(19) United States
(12) Patent Application Publication
(10) Pub. No.: US 2022/0114506 A1
(43) Pub. Date: Apr. 14, 2022

(54) Systems and Methods for Optimizing Multi-Modal Transportation

(71) Applicant: Joby Elevate, Inc., Santa Cruz, CA (US)

(72) Inventors: Ian Andreas Villa, San Francisco, CA (US); Ryan Patrick Naru, Oakland, CA (US); Raphael Max Lurie, San Francisco, CA (US); Adam Warmoth, San Francisco, CA (US); Karl Weston Schulz, Long Island City, NY (US)

(21) Appl. No.: 17/499,017

(22) Filed: Oct. 12, 2021

Related U.S. Application Data
(60) Provisional application No. 63/090,448, filed on Oct. 12, 2020.

(51) Int. Cl. G06Q 10/02; G06Q 10/06; G06Q 10/00; G06Q 50/30

(52) U.S. Cl. CPC G06Q 10/025; G06Q 50/30; G06Q 10/20; G06Q 10/063116

(57) ABSTRACT

Systems and methods for optimizing multi-modal transportation over a time period are provided. A system includes a simulation system configured to generate simulation data, a servicing system configured to generate servicing data, and a planning system configured to determine a multi-modal transportation itinerary based on the simulation and servicing data. The simulation data can identify a plurality of simulated flights performed in a simulated world corresponding to the real world. The system can determine the impact of scheduling a multi-modal transportation itinerary based on the impact of the multi-modal transportation itinerary on the simulated flights. The servicing data can include a servicing schedule that plans anticipated servicing events based on the impact of the servicing event to the simulated itineraries. Once scheduled, future simulated flights can be generated that account for the multi-modal transportation itinerary and the servicing schedule.

### RELATED APPLICATIONS

This application claims priority to and the benefit of U.S. Provisional Patent Application No. 63/090,448, filed Oct. 12, 2020, which is hereby incorporated by reference in its entirety.

### FIELD

The present disclosure relates generally to facilitating multi-modal transportation services for riders. More particularly, the present disclosure relates to systems and methods for optimizing multi-modal transportation services via simulations.

### BACKGROUND

A wide variety of modes of transport are available within cities. For example, people can walk, ride a bike, drive a car, take public transit, or use a ride sharing service. As population densities and demand for land increase, however, many cities are experiencing problems with traffic congestion and the associated pollution. Consequently, there is a need to expand the available modes of transport in ways that can reduce the amount of traffic without requiring the use of large amounts of land.

Air travel within cities can reduce travel time over purely ground-based approaches and alleviate problems associated with traffic congestion. Vertical takeoff and landing (VTOL) aircraft provide opportunities to incorporate aerial transportation into transport networks for cities and metropolitan areas. VTOL aircraft require much less space to take-off and land than other types of aircraft, making them more suitable for densely populated urban environments.

### SUMMARY

Aspects and advantages of embodiments of the present disclosure will be set forth in part in the following description, or can be learned from the description, or can be learned through practice of the embodiments.

Aspects of the present disclosure are directed to computing system including one or more processors and one or more tangible, non-transitory, computer readable media that collectively store instructions that when executed by the one or more processors cause the computing system to perform operations. The operations include obtaining data indicative of a request for a transportation service including at least an aerial transport for a rider of a multi-modal transportation service. The operations include obtaining simulation data indicative of a plurality of simulated flight itineraries at one or more time steps throughout an operational time period. The operations include generating a multi-modal transportation itinerary for facilitating the aerial transport for the rider based, at least in part, on the one or more simulated flight itineraries. The multi-modal transportation itinerary includes at least a first transportation leg, a second transportation leg, and a third transportation leg. And, the operations include providing the multi-modal transportation itinerary as an input for updating the plurality simulated flight itineraries.

Another aspect of the present disclosure is directed to another computing system including one or more processors and one or more tangible, non-transitory, computer readable media that collectively store instructions that when executed by the one or more processors cause the computing system to perform operations. The operations include obtaining vehicle data associated with a plurality of aerial vehicles. The vehicle data is indicative of a component state of one or more components for each of the plurality of aerial vehicles. The operations include obtaining simulation data indicative of a plurality of simulated flight itineraries at one or more time steps throughout an operational time period. The plurality of simulated flight itineraries are associated with at least one leg of a multi-modal transportation itinerary. The operations include generating a servicing schedule for one or more anticipated servicing events during the operational time period based, at least in part, on the vehicle data and the simulation data. And, the operations include outputting the servicing schedule.

Another aspect of the present disclosure is directed to another computing system including one or more processors and one or more tangible, non-transitory, computer readable media that collectively store instructions that when executed by the one or more processors cause the computing system to perform operations. The computing system can include a demand model configured to determine an anticipated demand for aerial transport services at one or more time steps throughout an operational time period. The computing system can include a candidate model configured to determine a respective plurality of candidate flight itineraries for each respective time step of the one or more time steps throughout the operational time period. The computing system can perform operations including obtaining, via the demand model, demand data for a first time step. The demand data can be indicative of an anticipated demand for aerial transport services at the first time step. The operations can include obtaining, via the candidate model, a first plurality of candidate flight itineraries for the first time step. The operations can include generating a plurality of simulated flight itineraries for the first time step based, at least in part, on the demand data and the plurality of candidate flight itineraries. The operations can include obtaining real time data associated with the first time step. The real time data can be indicative of a scheduled flight itinerary of the plurality of simulated flight itineraries. And, the operations can include updating one or more parameters of the demand model or the candidate model based, at least in part, on the real time data.

Another aspect of the present disclosure is directed to a computer-implemented method. The method can include obtaining, by a computing system including one or more computing devices, vehicle data associated with a plurality of aerial vehicles. The vehicle data is indicative of a component state of one or more components for each of the plurality of aerial vehicles. The method can include generating, by the computing system, a servicing schedule based, at least in part, on the vehicle data and simulation data indicative of a plurality of simulated flight itineraries at one or more time steps throughout an operational time period. The servicing schedule is indicative of the performance of one or more anticipated servicing events during the operational time period. The method can include obtaining, by the computing system, a request for one or more of the plurality of aerial vehicles for the performance of one or more aerial transportation services during the operational time period. The operations can include determining, by the computing system, one or more servicing options based, at least in part, on the vehicle data, the servicing schedule, and the request. The one or more servicing options can be indicative of one or more modifications to the servicing schedule and/or the one or more transportation services. And, the operations can include outputting, by the computing system, the one or more servicing options.

Another aspect of the present disclosure is directed to another computer-implemented method. The method can include obtaining, by a computing system comprising one or more computing devices, simulation data indicative of a plurality of simulated flight itineraries at one or more time steps throughout an operational time period. The method can include obtaining, by the computing system, real time data indicative of a deviation from at least one of the plurality of simulated flight itineraries. The method can include generating, by the computing system, a plurality of modified simulated flight itineraries based, at least in part, on the plurality of simulated flight itineraries and the real time data. And, the method can include updating, by the computing system, a multi-modal transportation itinerary associated with the deviation based, at least in part, on the plurality of modified simulated flight itineraries.

Yet another aspect of the present disclosure is directed to one or more tangible, non-transitory computer-readable media storing computer-readable instructions that when executed by one or more processors cause the one or more processors to perform operations. The operations can include obtaining vehicle data indicative of a plurality of vehicle attributes for a plurality of aerial vehicles. The operations can include obtaining simulation data indicative of a plurality of simulated flight itineraries at one or more time steps throughout an operational time period. The operations can include identifying one or more anticipated servicing events based on the simulation data and vehicle data. The operations can include generating a servicing schedule for the one or more anticipated servicing events. And, the operations can include outputting the servicing schedule.

Other aspects of the present disclosure are directed to various systems, apparatuses, non-transitory computer-readable media, user interfaces, and electronic devices. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

In some cases, the aspects of the present disclosure can utilize autonomous vehicle technology. The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, autonomous vehicles of the present disclosure may reduce traffic congestion in communities as well as provide alternate forms of transportation that may provide environmental benefits.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a graphical diagram of an example transportation node according to example embodiments of the present disclosure;

FIG. 3 depicts a graphical diagram of an example set of flight plans between an example set of transportation nodes according to example embodiments of the present disclosure;

FIG. 4 depicts an example vehicle provider ecosystem according to example embodiments of the present disclosure;

FIG. 5 depicts an example operational schedule according to example embodiments of the present disclosure;

FIG. 6 depicts a graphical diagram of an example multi-modal transportation service itinerary according to example embodiments of the present disclosure;

FIG. 7 depicts a data flow diagram for facilitating multi-modal transportation services throughout an operational time period according to example embodiments of the present disclosure;

FIG. 8 depicts models for generating example operational constraints according to example embodiments of the present disclosure;

FIG. 9 depicts a flow diagram of an example method for generating simulation data according to example embodiments of the present disclosure;

FIG. 10 depicts a flow diagram of an example method for generating servicing data according to example embodiments of the present disclosure;

FIG. 11 depicts a block diagram of an example computing system according to example embodiments of the present disclosure.

### DETAILED DESCRIPTION

Aspects of the present disclosure are directed to improved systems and methods for multi-modal transportation service systems. In particular, aspects of the present disclosure are directed to utilizing simulated multi-modal transportation itineraries to schedule real-time multi-modal services such as, for example, aerial transportation services, aerial vehicle servicing services, or both. For instance, a service entity can manage and coordinate a plurality of different types of vehicles to provide services to a plurality of riders via a transportation platform. A service entity computing system associated with the service entity (e.g., a cloud-based computing system, etc.) can obtain data indicative of a service request from one or more riders and generate one or more multi-modal transportation itineraries (e.g., rider itinerary, ground itinerary, flight itinerary, etc.) to facilitate transporting the rider from the origin location to the destination location. The multi-modal transportation itinerary can include at least two types of transportation such as, for example, a ground-based vehicle transportation and an aerial transportation. For example, the itinerary can include three legs: a first leg that includes a ground-based vehicle transporting a rider from the origin location (e.g., a home, etc.) to a first aerial transport facility; a second leg (e.g., an aerial portion) that includes an aircraft transporting the rider from the first aerial transport facility to a second aerial transport facility; and a third leg that includes another ground-based vehicle transporting the rider from the second aerial transport facility to the destination location (e.g., a conference center).

The service entity computing system can leverage simulation data to optimize multi-modal transportation itineraries over an operational time period (e.g., hour(s), day(s), week(s), etc.). The simulation data can include a number of simulated transportation itineraries initiated and simulated based on a number of operational constraints representing the real world at one or more times throughout the operational time period. For example, a simulated transportation itinerary at a respective time step (e.g., a current time step, a future time step subsequent to the current time step, etc.) can be generated based on a real-time observation or an expectation of demand, vehicle availability, and/or environmental conditions throughout the operational time period (e.g., at the current time step, a one or more future time steps subsequent to the current time step, etc.). Each simulated transportation itinerary can be initiated in a simulated world environment to determine its expected impact on one or more metrics (e.g., an overall noise level, profit margin, ride quality, safety level, fueling/charging efficiency, etc.) of an operational time period if scheduled in the real world. A number of simulated transportation itineraries can be generated and ranked (e.g., according to its expected impact) for each time step of the operational time period. Upon receiving data indicative of a service request, the service entity computing system can select (e.g., from among a ranked list of simulated itineraries) a simulated itinerary and generate a multi-modal transportation itinerary based on the selected simulated itinerary. The selected simulated itinerary can be initiated in the real world (e.g., by scheduling a vehicle to provide one or more legs of the itinerary, etc.) and used to update the number of operational constraints (e.g., a vehicle availability, an expectation of demand, etc.) representing the real world. The service entity computing system can regenerate the simulated transportation itineraries based on the updated operational constraints. In this manner, the service entity computing system can generate optimal multi-modal transportation itineraries and/or modify scheduled multi-modal transportation itineraries based on simulation data that can anticipate and react to changes in the real world environment.

In addition, the service entity computing system can leverage servicing data to detect and schedule servicing events (e.g., vehicle maintenance, vehicle charging/fueling, etc.) during an operational time period for vehicles configured to provide services for the service entity and optimize the simulated transportation itineraries to account for the servicing events. This can include, for example, modifying a departure time for an aerial leg of a transportation itinerary to accommodate one or more charging and/or fueling advantages/disadvantages, etc. To do so, the service entity computing system can obtain vehicle data (e.g., from service entity vehicles, from third-party vehicle providers, etc.) associated with the vehicles and the simulation data described herein. The vehicle data can identify a component state (e.g., charge level, last date of servicing, structural integrity, etc.) for a number of components (e.g., a power component (e.g., a battery, fuel tank, etc.), one or more other hardware components, one or more software components, etc.) of each of the vehicles. The components can include any electrical, mechanical, or software component or portions thereof of an aerial vehicle. Based on the vehicle and simulation data, the service entity computing system can identify a number of servicing events and generate a servicing schedule for the one or more anticipated servicing events during the operational time period. By utilizing the simulation data, the servicing schedule can be generated such that the impact of the anticipated servicing events during the operational time period can be minimized without endangering the health (e.g., short-term or long-term) of the vehicles. Once generated, the servicing schedule can be utilized to update one or more of the number of operational constraints with which the number of simulated itineraries are generated. In this way, the number of simulated itineraries can anticipate one or more servicing events throughout the operational time period and plan accordingly. In addition, or alternatively, the servicing schedule can be provided to a third-party vehicle provider to enable the vehicle provider to anticipate servicing events throughout an operations time period.

In this manner, the systems and methods of the present disclosure provide improved techniques for facilitating, planning, and optimizing a number of multi-modal transportation services, as well as the vehicles themselves, throughout an operational time period. For instance, a system can simulate the provisioning of a plurality of multi-modal transportation itineraries under a number of different transportation scenarios based on real world constraints. The simulated multi-modal transportation itineraries can be simulated before a multi-modal transportation itinerary is scheduled for a current time step and can anticipate servicing events throughout the operational time period. In this way, the system can obtain simulated data identifying the future consequences of a multi-modal transportation itinerary and schedule the itinerary based on the future consequences. In this manner, the systems and methods of the present disclosure provide improved techniques for leveraging simulation data and servicing data to generate a new type of multi-modal transportation itinerary specifically tailored to optimize one or more metrics associated with an operational time period. This, in turn, enables the system to optimally schedule a plurality of multi-modal transportation itineraries with a better, more holistic understanding of the future consequences of the plurality of multi-modal transportation itineraries to one or more goals of an operational time period.

More particularly, a service entity can be associated with a service entity computing system (e.g., a cloud-based operations computing system, etc.) that is configured to manage, coordinate, simulate, and/or dynamically adjust a multi-modal transportation service via a transportation platform. The transportation platform, for example, can be communicatively connected over a network to a plurality of users (e.g., via one or more user devices such as the first user device, etc.), a plurality service providers (e.g., via one or more service provider devices), one or more vehicle operators (e.g., providing vehicles for use on the platform), etc. The multi-modal transportation service can include a plurality of transportation legs, one of which (e.g., a second transportation leg) can include an aerial transportation of a rider. For example, the service entity computing system can obtain a request for a transportation service. The request for the transportation service can include at least a request for an aerial transport of a rider of the transportation platform. To facilitate the transportation service, the system can create an end-to-end multi-modal itinerary that includes two or more transportation legs that include travel via two or more different transportation modalities such as, for example: cars, light electric vehicles (e.g., electric bicycles or scooters), buses, trains, aircraft, watercraft, and/or other transportation modalities. Example aircrafts can include helicopters and/or other vertical take-off and landing aircraft (VTOL) such as electric vertical take-off and landing aircraft (eVTOL).

The vehicles can include non-autonomous, semi-autonomous, and/or fully-autonomous vehicles. In some implementations, one or more vehicles can be provided by a vehicle provider so that the vehicle(s) can be utilized by the transportation platform for the provision of transportation services for one or more legs. For instance, each vehicle can include a service entity vehicle provided and/or maintained by a service entity vehicle provider associated with the computing system and/or a third party vehicle provided and/or maintained by a third party vehicle provider. As described herein, the computing system can provide cross-platform support to third party vehicle providers. For instance, the computing system can provide access to one or more services of the computing system to systems (e.g., third-party vehicle computing systems, third-party air traffic control systems, etc.) associated with third party vehicle providers.

The computing system can perform one or more algorithms to generate the end-to-end multi-modal itinerary for a rider. As an example, the computing system can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

A transportation modality (e.g., a flight-based modality) can operate according to or within a fixed transportation infrastructure in which the ability of riders to embark and disembark vehicles is constrained to a defined set of transportation nodes. For example, the fixed transportation infrastructure can include a plurality of aerial vehicles (e.g., service entity aircraft, third-party aircraft, etc.) that operate within a ride sharing network facilitated by the computing system. The aerial vehicle(s) can be constrained to load and unload riders only at a defined set of physical take-off and/or landing areas which may in some instances be referred to as aerial transport facilities. Each aerial transport facility can include one or more landing pads and/or other infrastructure to enable riders to safely embark or disembark from aerial vehicles. Aerial transport facilities can also include charging equipment, cooling equipment, re-fueling equipment, and/or other infrastructure for enabling aircraft operation and/or servicing.

The computing system can identify a set of candidate transportation plans that can form the basis for building a set of potential itineraries. As described in further detail herein, the set of candidate transportation plans can include each possible transportation itinerary between each node of the fixed transportation infrastructure at a respective time. The computing system can stitch additional transportation legs to each respective candidate transportation plan to generate a plurality of candidate end-to-end itineraries. The computing system can analyze the candidate itineraries to select one or more itineraries that are high quality according to various measures. The computing system can interact with one or more vehicles (e.g., aerial vehicles, ground vehicles, etc.) and/or one or more vehicle providers or service providers (e.g., pilots, drivers, remote operators, etc.) of the one or more vehicles to enable the rider to complete at least one of the one or more itineraries. The service providers, for example, can include a service entity service provider associated with the computing system and/or one or more third-party service providers. In some implementations, the service provider can include a human operator (e.g., driver or pilot) and/or a vehicle computing system.

More particularly, the computing system can include and/or be associated with a number of subsystems (e.g., world state system, forecasting system, optimization system, matching and fulfillment system, etc.) configured to provide a plurality of backend services to facilitate a transportation service. By way of example, an optimization/planning system can provide a backend itinerary service to generate one or more itineraries for a rider in accordance with the procedures described herein. In addition, the optimization/planning system can provide a backend routing service to determine one or more flight plans, routes, skylanes, etc. for vehicles associated with transportation service. Moreover, the computing system can include a world state system, a forecasting system, and/or any other system capable of facilitating a transportation service. As one example, a world state system can operate a state monitoring system to maintain data descriptive of a current state of the world (e.g., a predicted transportation demand, flight assignments, operational statuses and locations of a plurality of vehicles, etc.). For instance, the world state system can be configured to obtain world state data through communication (e.g., via an API platform) with one or more vehicles, vehicle providers, and/or any other transportation entity associated with the computing system. As another example, a forecasting system can operate a forecasting service to generate predictions of transportation demand, weather forecasts, and/or any other future looking data helpful for completing a transportation service.

The computing system can interact with various vehicle providers (e.g., third-party vehicle providers, service entity vehicle providers, etc.). To do so, the computing system can include an application programming interface platform to facilitate services between the service entity infrastructure (e.g., the services of the computing system, service entity vehicle providers, etc.) and third party vehicle providers. The API platform can include one or more functional calls to the backend services of the computing system. By way of example, the one or more functional calls can be configured to communicate a request and/or data between one or more subsystems (e.g., world state system, forecasting system, optimization/planning system, etc.) of the computing system and one or more transportation entities associated with a transportation service (e.g., aerial vehicles, air traffic controllers, ground vehicles, pilots, passengers, etc.).

To help optimize multi-modal transportation services provided throughout an operational time period, the computing system (e.g., a simulation system) can generate and initiate a number of simulation instances for each time step of the operational time period. The operational time period, for example, can include any unit of time during which transportation services and/or servicing services are provided. By way of example, the operational time period can include a one or more hours, days, weeks, etc. of operations.

Each simulation instance can include a simulated flight itinerary (and/or a simulated end-to-end multi-modal transportation itinerary including the simulated flight itinerary as at least one leg) performed in a simulated world environment representing one or more constraints (e.g., demand constraints, vehicle constraints, weather constraints, etc.) of the real world at a respective time step. For example, the simulated world environment at a current time step can represent the current state of the real world as maintained by the world state system. The simulated world environment at a respective time step subsequent to the current time step can represent a predicted state of the real world as determined by the forecasting system. Simulated itineraries generated for the respective time step subsequent to the current time step can be determined and simulated based on a simulated itinerary generated for the current time step and the predicted state of the real world at the respective time step. In this manner, the number of simulated itineraries can illustrate the impact that a simulated itinerary at a current time step can have on a number of subsequent itineraries (and/or an availability thereof). By obtaining simulation data indicative of a plurality of simulated itineraries for the operational time period, the computing system (e.g., the optimization/planning system) can generate a multi-modal transportation itinerary for a current and/or future time step based on future insights provided by the simulation data.

For example, the computing system (e.g., optimization/planning system) can receive multi-modal transportation data indicative of one or more requests for a plurality of transportation services and generate the plurality of multi-modal transportation itineraries for facilitating the plurality of transportation services. An aerial vehicle can be assigned (e.g., based on vehicle data) to provide at least one leg of the multi-modal transportation itinerary. For example, the multi-modal transportation itinerary can include at least one aerial transportation leg. The aerial vehicle can be assigned to provide the at least one aerial transportation leg. The computing system (e.g., matching and fulfillment system) can schedule, track the progress of, and/or modify each of the plurality of multi-modal transportation itineraries and/or one or more transportations legs (e.g., the at least one aerial transportation leg) thereof during operational time period. The computing system can generate a new multi-modal transportation itinerary and/or modify at least one of the plurality of multi-modal transportation itineraries based on the progress of each of the multi-modal transportation itineraries and/or additional multi-modal transportation data (e.g., indicative of one or more additional requests, etc.). At times, the generation or modification of one multi-modal transportation itinerary can negatively affect one or more potential future itineraries.

The computing system (e.g., optimization/planning system) can leverage the future insights provided by the simulation data to optimize each scheduled and/or modified multi-modal transportation itinerary over the operational time period. The simulation data can be generated (e.g., by a simulation computing system) based on multi-modal transportation data, vehicle data, candidate itinerary data, servicing data (e.g., charging/fueling advantages, etc.), environmental data, and/or any other data indicative of the current and/or future state of the world. For example, the multi-modal transportation data can include one or more anticipated, real-time, or scheduled requests for an aerial transportation service. For instance, the one or more requests can include one or more real-time requests received at a current time step, one or more scheduled requests received at a time step preceding the current time step and assigned to a scheduled multi-modal transportation itinerary, and/or one or more anticipated requests (e.g., an anticipated demand for multi-modal transportation services). The one or more anticipated requests can include an estimated number of requests that will be received at one or more time steps throughout the operational time period.

For example, the multi-modal transportation data can include demand data indicative of a plurality of anticipated requests and/or one or more aspects thereof. For instance, the demand data can be indicative of the one or more anticipated transportation services throughout the operational time period. By way of example, the computing system (e.g., the forecasting system) can include a network model configured to predict the plurality of anticipated requests based on historical and/or real-time data. In some implementations, the network model can include one or more machine-learning models. The machine-learning models can include any machine-learning model (e.g., deep neural networks, convolutional neural networks, recurrent neural networks, recursive neural networks, decision trees, logistic regression models, support vector machines, etc.) and/or any other models configured to generate the demand data based on one or more inputs. In some implementations, the one or more machine-learning models can be learned (e.g., via one or more supervised training techniques) over a set a training data such as, for example, historical multi-modal transportation service data gathered over one or more previous operational time periods.

More particularly, the network model can include a demand model, a load modal, and/or an aerial transport usage model. The demand model can be configured to determine an anticipated demand for aerial transportation services at one or more time steps throughout the operational time period. The load model can be configured to estimate the maximum expected load factors at one or more time steps throughout the operational time period. A load factor, for example, can identify at total expected weight to be transported. The aerial transport usage model can be configured to estimate an expected number of flights for each aerial transport facility and/or aerial vehicle of the fixed transportation infrastructure at one or more time steps throughout the operational time period. For example, the aerial transportation usage model can identify an expected number of aerial vehicles that will land, park, receive servicing (e.g., maintenance, fueling, charging, etc.), and/or take off from each of a plurality of aerial transport facilities.

In some implementations, the multi-modal transportation data can include itinerary data indicative of a number of services expected to be requested during the operational time period and one or more expected transportation request attributes of each of the expected service requests. The one or more expected transportation request attributes, for example, can include a type of requested service (e.g., single passenger transportation, group passenger transportation, item transportation, etc.), a time sensitivity of the requested service, a capacity sensitivity of the requested service, one or more locations (e.g., origin, destination, etc.) associated with the requested service, etc. For example, the attribute(s) can identify an aerial transport facility (e.g., an origin facility, an intermediate facility, a destination facility, etc.) associated with each expected requests, a number of services expected to be fulfilled by each aerial transport facility, a number/type aerial vehicles needed to service each of the expected requests, a number/type of aerial vehicles at each aerial transport facility needed to service the expected requests, etc.

The candidate itinerary data can be indicative of a plurality of candidate flight itineraries at a respective time step during the operational time period. The candidate itinerary data can be generated by a candidate model configured to determine the availability of a plurality of candidate itineraries between a plurality of aerial transport facilities at one or more time steps throughout the operational time period. In some implementations, the candidate model can include one or more machine-learning models. The machine-learning models can include any machine-learning model (e.g., deep neural networks, convolutional neural networks, recurrent neural networks, recursive neural networks, decision trees, logistic regression models, support vector machines, etc.) and/or any other models configured to generate the candidate itinerary data based on one or more inputs. In some implementations, the one or more machine-learning models can be learned (e.g., via one or more supervised training techniques) over a set a training data such as, for example, historical candidate itinerary data gathered over one or more previous operational time periods.

The candidate model can be configured to determine a respective plurality of candidate flight itineraries for one or more time steps throughout the operational time period. The respective candidate flight itineraries can include every possible flight itinerary that is available between each aerial transport facility of a fixed transportation infrastructure at a respective time step of the operational time period. The candidate data can be determined based on the number and/or type of aerial vehicle(s) available at each facility at the respective time step, a number of skylanes available at the respective time step, the number and/or availability of take-off/landing points of each aerial transport facility, etc.

The vehicle data can be indicative of a component state of one or more vehicle components for each of the plurality of aerial vehicles. For example, the vehicle data can include a vehicle model for each respective aerial vehicle. For instance, each respective aerial vehicle of the plurality of aerial vehicles can include a corresponding vehicle model uniquely tailored to the attributes of the aerial vehicle.

The vehicle data can be indicative one or more vehicle attributes associated with a plurality of aerial vehicles of the fixed transportation infrastructure. For example, the service entity computing system can utilize a plurality of aerial vehicles for facilitating aerial transportation services for a number of riders. Each of the vehicles can be stored, maintained, serviced, and/or otherwise associated with a respective aerial transport facility at one or time steps of the operational time period. Each vehicle can be associated with vehicle data indicative of a state (e.g., location, power level, etc.) of the vehicle at one or more time steps of the operational time period. For example, the vehicle data for a respective vehicle can include one or more of battery health data (e.g., a current, predicted, etc. power level of the vehicle), a vehicle health data (e.g., a state of one or more components such as a battery, etc. of the vehicle), pilot health data (e.g., a current, predicted, etc. energy level of an operator of the vehicle), usage data (e.g., flight hours, etc.), or location data (e.g., current, predicted, etc. location of the vehicle) associated with the respective vehicle.

As an example, each vehicle can be associated with a vehicle model indicative of one or more vehicle attributes. The vehicle attributes can include one or more operational capabilities, a list of components and/or types of components of the aerial vehicle, and/or a current state and/or health of each of the aerial components. The aerial components, for example, can include one or more hardware components and/or software components for each of the plurality of aerial vehicles. The hardware components can include at least one power component (e.g., an engine, fuel tank, battery, etc.), climate control component, navigation component, flight control component, etc. The one or more software components can include one or more software applications (e.g., an operating system, a user interface, etc.) associated with the aerial vehicle. The current state of each of the aerial components can identify a health (e.g., a power level, a current software version, etc.) of each of the one or more components. For example, the current state of a power component can identify a power level (e.g., fuel level, charge level, etc.) of the power component (e.g., battery, fuel tank, etc.) for a respective aerial vehicle.

In addition, or alternatively, the vehicle model can be indicative of usage information (e.g., historical usage, current usage, expected usage, etc.) for a respective aerial vehicle. The usage data can be indicative historical, current, and/or expected flight time for the vehicle and/or the operator of the vehicle. In some cases, the current state of an aerial vehicle can be determined based at least in part on the usage data.

In some implementations, the vehicle model can be associated with one or more component models. For example, the vehicle model can be associated with a battery model modelling one more attributes of a battery of the aerial vehicle. For instance, the battery model can be indicative of one or more performance characteristic(s) of an electric battery of a respective aerial vehicle. The performance characteristics can be indicative of an expected long term performance (e.g., life expectancy) of the battery and/or an expected short term performance (e.g., charge level) of the battery. In addition, the performance characteristics can be indicative of servicing (e.g., slow charge, fast charge, etc.) that can affect the expected long term and/or short term performance of the battery. The battery model can include structural information such as a type of cells used, the chemistry within each of the cells, an organizational structure of the cells, how cell modules are packed together, materials used that may affect the dissipation of heat, etc. In some implementations, the performance characteristics of the electric battery can be determined based, at least in part, on the structural information.

The simulation data can be generated (e.g., by a simulation system) based on the multi-modal transportation data, the candidate itinerary data, and/or the vehicle data. The simulation data can be indicative of a plurality of simulated flight itineraries at one or more time steps throughout the operational time period. The plurality of simulated flight itineraries can be associated with one or more multi-modal transportation itineraries. For example, each simulated flight itinerary can include at least one transportation leg of a multi-modal transportation itinerary. A simulated flight itinerary can include a flight itinerary performed within a simulated word environment. The simulated world environment can match the real world and use the real world as constraints on the generation of simulated flight itineraries and the performance of the simulated flight itineraries.

The computing system (e.g., simulation system) can generate the plurality of simulated itineraries based on the one or more operational constraints. The one or more operational constraints can represent real time and/or predicted demand, supply, weather, and/or any other factor that can affect transportation services throughout an operational time period. The one or more operational constraints can be defined based, at least in part, on the data described herein. The computing system (e.g., simulation system) can simulate a plurality of flight itineraries for each time step throughout the operational time period. For instance, at each respective time step, the computing system (e.g., simulation system) can generate a plurality of flight itineraries based on real-time data up to a current time step and predicted data for one or more time steps subsequent to the current time step. The real-time and/or predicted data can be represented as the one or more operational constraints.

As discussed herein, the computing system can include and/or have access to one or more models (e.g., network model, candidate models, optimization model, etc.) configured determine the one or more operational constraints. Each of the models can determine the one or more constraints based on real time data. The real time data can be indicative of at least one of a number of requests for aerial transport services, one or more scheduled flight itineraries, vehicle data, and/or environment data at and/or up to a current time step. As an example, the network model can estimate updated demand data for each respective time step of the operational time period based on a real-time demand (e.g., as indicated by requests for aerial transportation services, one or more scheduled flight itineraries, etc.) for aerial transport services at and/or up to the respective time step for which it is available. As another example, the environmental data can be estimated based on real-time weather data, traffic data, etc. indicative of the current weather and/or traffic conditions. For example, the environmental data can be indicative of one or more environmental conditions (e.g., weather, traffic, etc.) at and/or up to the current time step.

The computing system can generate the plurality of simulated flight itineraries based on the one or more operational constraints and/or the one or more candidate flight itineraries as determined by the one or models (e.g., network model, candidate model, world state system, forecasting system, etc.). The one or more operational constraints can include one or more demand constraints, multi-modal itinerary constraints, vehicle constraints, and/or environmental constraints for one or more time steps throughout the operational time period. For example, the computing system can obtain, via the demand model, demand data for a respective time step. The demand data can be indicative of an anticipated demand for aerial transport services at the respective time step. In addition, or alternatively, the computing system can obtain, via the candidate model, a plurality of candidate flight itineraries for the respective time step. The computing system can generate a plurality of simulated flight itineraries for the respective time step based, at least in part, on the demand data and the plurality of candidate flight itineraries. This process can be repeated for one or more time steps throughout the operational time period based on any combination of the data described herein.

The computing system can optimize the scheduling of a plurality of itineraries in view of the operational time period. For example, in some implementations, the computing system can generate an optimal list of itineraries for a respective time step (e.g., a current time step) of the operational time period based on the plurality of simulated flight itineraries. The optimal list of itineraries can include a ranked list of simulated itineraries. The itineraries can be ranked according to an estimated impact that scheduling the itinerary will have on one or more anticipated itineraries during the operational time period. In addition, or alternatively, the itineraries can be ranked according to an estimated impact on the aerial vehicles associated with the itineraries. For instance, the itineraries can be ranked based on the impact each itinerary will have on the health (e.g., long-term/short-term battery health) of different vehicles assigned to perform the itineraries throughout the operational time period.

For example, the computing system can determine contextual data for each of a plurality of simulated flight itineraries generated for the respective time step. The contextual data can be indicative of a relative impact of a respective simulated flight itinerary on one or more metrics associated with the operational time period. The one or more metrics, for example, can include an overall noise level (e.g., noise caused by aircraft during the provision of an aerial transportation service), an overall profit margin (e.g., profit earned by the provision of the aerial transportation service(s)), an overall ride quality (e.g., an expectation of delays, etc.), an overall safety level, an overall vehicle health impact, and/or any other measurement observed throughout an operational time period. The relative impact of the respective simulated flight itinerary can be determined based, at least in part, on a plurality of subsequent simulated flight itineraries generated for one or more time steps subsequent to the respective time step. The plurality of subsequent simulated flight itineraries can be generated based, at least in part, on the respective simulated flight itinerary and one or more operational constraints (e.g., an anticipated demand, a plurality of candidate flight itineraries, etc.) for the one or more time steps subsequent to the respective time step.

The computing system can generate an optimal list of itineraries including a ranked list of a subset of the plurality of simulated flight itineraries based, at least in part, on the contextual data for each of the plurality of simulated flight itineraries. Each simulated flight itinerary of the optimized list of flight itineraries can be ranked based, at least in part, on a relative impact of the simulated flight itinerary to one or more of the metrics of the operational time period. As an example, the simulated flight itineraries can be ranked according to a cost function configured to minimize a predicted overall noise level, maximize a predicted profit margin, maximize a predicted overall ride quality, maximize vehicle safety, minimize negative long-term/short-term vehicle component health impacts (e.g., by anticipating and avoiding probabilistic failures for aerial vehicles and/or vehicle components), etc. for the plurality of flight itineraries scheduled during the operational time period. As an example, the cost function can evaluate a plurality of subsequent itineraries generated based on a simulated itinerary at a respective time step. The plurality of subsequent itineraries can include one or more sets of itineraries that are possible and/or likely after the simulated itinerary is scheduled. The cost function can analyze each combination of sets of itineraries to determine an estimated noise level, profit margin, ride quality, vehicle safety, positive/negative long-term/short-term vehicle component health impact, etc. and/or identify probabilistic vehicle (and/or component failures) for each possible and/or likely combination of itineraries after the simulated itinerary is scheduled. The contextual data for the simulated itinerary can include an indication of the estimated noise level, profit margin, ride quality, vehicle safety, positive/negative long-term/short-term vehicle component health impact, and/or potential for vehicle (and/or component) failures for the operational time period in the event that the simulated itinerary is scheduled.

The cost function can be determined based on historical data indicative of a plurality of historical scheduled itineraries and metrics for each of the plurality of historical scheduled itineraries. In some implementations, the contextual data can be determined by one or more machine-learning costing models. The one or one or more machine-learning costing models can include any machine-learning model (e.g., deep neural networks, convolutional neural networks, recurrent neural networks, recursive neural networks, decision trees, logistic regression models, support vector machines, etc.) and/or any other models configured to determine the contextual data based on one or more inputs. In some implementations, the one or more machine-learning models can be learned (e.g., via one or more supervised training techniques) over a set a training data such as, for example, the plurality of historical scheduled itineraries, historical vehicle models, and/or metrics thereof.

The computing system (e.g., the optimization/planning system) can generate a multi-modal transportation itinerary by selecting a flight itinerary from the optimal list of simulated flight itineraries to facilitate an aerial transportation leg of the multi-modal transportation itinerary for a rider. For example, the computing system can obtain the optimized list of flight itineraries for a respective time step associated with a request for the aerial transport. In some implementations, the optimized list of flight itineraries can be provided for display, via one or more display devices, to one or more users of the computing system (e.g., one or more aerial transportation operators, schedulers, etc.). In such a case, each flight itinerary of the optimized list of flight itineraries can be displayed with contextual data associated with the respective flight itineraries.

The computing system (and/or user thereof) can select a flight itinerary from the optimized list of flight itineraries for a transportation leg of the multi-modal transportation itinerary associated with the aerial transport of the rider from the optimized list of flight itineraries. For example, the computing system can obtain simulation data, vehicle data, one or more candidate itineraries, and/or multi-modal transportation data associated with the respective time step and select the flight itinerary based on this data. The selection of the selected flight itinerary can be performed by the computing system, via a selection algorithm of the computing system, and/or by a user of the computing system, via user input. For example, the selection algorithm can include an automatic selection logic that selects a flight itinerary based on one or more attributes (e.g., highest ranked itinerary, lowest ranked itinerary, etc.) of the contextual data accompanying the optimal list of flight itineraries. In addition, or alternatively, the computing system can receive user input indicative of a selection of the selected flight itinerary. The user input can be received via one or more input devices (e.g., microphone, tactile device (e.g., keyboard, mouse, button, etc.), etc.) of the computing system.

The computing system (e.g., the matching and fulfillment system) can initiate the performance of the selected itinerary. For example, the computing system can generate a multi-modal transportation itinerary based on the selected flight itinerary. The selected flight itinerary, for example, can include at least one transportation leg of the multi-modal transportation itinerary. The computing system can assign one or more vehicles to provide one or more legs of the multi-modal transportation itinerary and facilitate the provision of a multi-modal transportations service for a rider of the multi-modal transportation itinerary.

The computing system (e.g., the optimization/planning system) can provide data indicative of the multi-modal transportation itinerary as an input for updating the plurality simulated flight itineraries. For example, the one or more operational constraints can be updated at each time step (e.g., each minute, five minutes, fifteen minutes, hour, etc.) throughout the operational time period based, at least in part, on real time data. By way of example, once selected, the one or more multi-modal itinerary constraints indicative of one or more scheduled multi-modal transportation itineraries can be updated based, at least in part, on the multi-modal transportation itinerary. The computing system can regenerate each of the plurality of simulated flight itineraries of the simulation data based on the updated multi-modal itinerary constraints. In this manner, the plurality simulated flight itineraries of the simulation data can be updated at each respective time step throughout the operational time period based, at least in part, on the one or more updated operational constraints at the respective time step.

As another example, the computing system can obtain real time data associated with a respective time step. The real time data can be indicative of a scheduled flight itinerary of the plurality of simulated flight itineraries. The computing system can update one or more parameters of the network model, demand model, candidate model, etc. based, at least in part, on the real time data. For example, the computing system can obtain, via the demand model, updated demand data for the first time step. The updated demand data can identify the real-time demand for aerial transport services at the first time step. In addition, or alternatively, the computing system can obtain, via the candidate model, an updated plurality of candidate flight itineraries for the first time step. The computing system can modify the plurality of simulated flight itineraries for the first time step based, at least in part, on the updated demand data and/or the updated plurality of candidate flight itineraries.

In addition, or alternatively, the computing system can obtain real time data indicative of a deviation from at least one of the plurality of simulated flight itineraries. The deviation from the at least one of the plurality of simulated flight itineraries can include an unanticipated occurrence for a scheduled flight itinerary corresponding to the simulated flight itinerary that causes the scheduled flight itinerary to deviate from the simulated flight itinerary. The deviation can be indicative of at least one of an environmental condition, a flight delay, and/or a traffic delay. By way of example, the unanticipated occurrence can include greater traffic congestion than anticipated, a late/early passenger, a larger/lower than expected capacity, one or more weather anomalies, one or more unanticipated vehicle component failures, etc. and the one or more deviations can include a delayed/early flight itinerary, an earlier/later departure time, an earlier/later landing time, a lower/higher anticipated power expenditure for a vehicle providing the aerial transportation service for the flight itinerary, etc.

In response to obtaining the real time data indicative of the deviation, the computing system can generate a plurality of regenerated simulated flight itineraries based, at least in part, on the plurality of simulated flight itineraries and the real time data. The computing system can update a multi-modal transportation itinerary associated with the deviation based, at least in part, on the plurality of regenerated simulated flight itineraries. For example, the computing system can assign a different vehicle for providing the aerial transportation service of the multi-modal transportation itinerary, replace the aerial transportation leg of the multi-modal transportation itinerary with a different flight itinerary, etc.

In some implementations, the simulation data can be generated and/or modified based, at least in part, on servicing data. The servicing data can include a servicing schedule for one or more anticipated servicing events during the operational time period. An anticipated servicing event can identify a potential opportunity for servicing an aerial vehicle during the operational time period. Servicing an aerial vehicle can include refueling, recharging, and/or repairing one or more components of the aerial vehicle. As discussed in further detail herein, the anticipated servicing events can be identified based on a health of one or more components of an aerial vehicle. In this way, the anticipated servicing events can be identified and scheduled during an operational time period to maintain the operational capabilities of an aerial vehicle. In some cases, the plurality of simulated and/or scheduled itineraries can be modified (e.g., by changing a departure time, arrival location, etc.) based at least in part on the anticipated (and/or unanticipated) servicing events. For instance, as described in further detail herein, a departure time for a scheduled itinerary can be postponed in order to allow a vehicle to be “slow-charged” to limit the long-term negative impact to the aerial vehicle. At times, the decision to postpone the departure time can be based at least in part on an unanticipated occurrence such as, for example, a late passenger associated with the scheduled itinerary, an additional passenger arriving to take an empty seat, etc.

Each anticipated servicing event can include one or more servicing attributes. The one or more servicing attributes can include an aerial vehicle identifier, a servicing type, and/or an estimated time or infrastructure for performing the anticipated servicing event. The aerial vehicle identifier can identify an aerial vehicle associated with the servicing event. For example, the aerial vehicle identifier can include an aerial vehicle identification number, a license plate, and/or any other number or text unique to a respective aerial vehicle of the plurality of aerial vehicles that operate within the ride sharing network facilitated by the computing system. The servicing type can be indicative of a type (e.g., refueling, recharging, repairing, etc.) of servicing to be performed on the aerial vehicle. For example, the servicing types can identify whether the anticipated servicing event is associated with refueling the aerial vehicle and/or repairing one or more components of the aerial vehicle. As an example, the servicing type can be associated with a component (e.g., climate control component, flight control component (e.g., rotor, blade, windshield, etc.), etc.) of the aerial vehicle. The estimated time and/or infrastructure for performing the anticipated servicing event can include an estimated time (e.g., average time for fueling/charging a vehicle, etc.) and/or a required infrastructure (e.g., charging interfaces/materials, fueling interfaces/materials, other tools, interfaces, and/or materials for repairing one or more components of the aerial vehicle) for completing an anticipated servicing event of a certain type.

The servicing schedule can be indicative of an availability of one or more aerial vehicles throughout the operational time period. The computing system (e.g., simulation system) can obtain the servicing schedule and update one or more simulated itineraries of the simulation data based on the availability of the one or more aerial vehicles. For example, the computing system (e.g., servicing system) can provide the servicing schedule as an input for updating the plurality simulated flight itineraries. For instance, the one or more vehicle constraints can be indicative of an availability of one or more of the plurality of aerial vehicles. At times, the availability of one or more of the plurality of aerial vehicles can include potential availabilities for the vehicles depending on a type of charge applied to the vehicles during an anticipated servicing event (e.g., the availability of an aerial vehicle can be dependent on whether the vehicle receives a fast-charge, a slow-charge, a power level with which it is charged to, etc.). The one or more vehicle constraints can be updated based, at least in part, on the servicing schedule. The one or more operational constraints can be updated at each time step throughout the operational time period based, at least in part, on real time data indicative of the performance of at least one of the one or more anticipated servicing events.

The computing system (e.g., servicing system) can generate servicing data (e.g., servicing schedule) for one or more time steps throughout the operational time period. The servicing data can be generated based on real-time data (e.g., up to a respective time step), simulation data, vehicle data, and/or any other data described herein. For instance, the computing system can obtain vehicle data associated with a plurality of aerial vehicles. As discussed herein, the vehicle data can be indicative of a component state of one or more components for each of the plurality of aerial vehicles. In addition, the computing system can obtain simulation data indicative of the plurality of simulated flight itineraries at one or more time steps throughout the operational time period. The computing system can generate the servicing schedule for one or more anticipated servicing events during the operational time period based, at least in part, on the vehicle data and the simulation data and output the servicing schedule (e.g., to the optimization/planning system, the simulation system, etc.).

More particularly, the computing system can determine an anticipated schedule for at least one aerial vehicle of the plurality of aerial vehicles based, at least in part, on the simulation data. The computing system can identify the anticipated servicing event for the at least one aerial vehicle based, at least in part, on the anticipated schedule and vehicle data associated with the aerial vehicle. By way of example, the anticipated servicing event can be identified based on vehicle usage data indicative of the expected utilization of the at least one aerial vehicle. For instance, the vehicle usage data can identify an expected power level decrease, an expected hardware degradation, etc. due to the performance of one or more aerial vehicle services. As an example, a power level can be predicted (via one or more simulated itineraries, etc.) for completing an anticipated schedule of aerial vehicle services for a respective aerial vehicle. The predicted power level can be compared to the current power level (e.g., as indicated by the vehicle data) of an aerial vehicle and a servicing event can be anticipated for recharging/fueling the vehicle at a time step where the vehicle is not expected to be in use and requires (or could optimally use) a recharge/refuel.

In some implementations, the computing system can determine a servicing time period during the operational time period for the performance of the anticipated servicing event based, at least in part, on the anticipated servicing event, the vehicle data associated with the aerial vehicle, and the simulation data. The servicing time period can be determined to minimize the impact of the anticipated servicing event on the plurality of simulated flight itineraries. In addition, or alternatively, the computing system can obtain servicing data associated with one or more servicing locations and/or one or more servicing personnel. For instance, the servicing data can be indicative of an availability of the one or more servicing locations or the one or more servicing personnel. The computing system can determine the servicing time period and/or a servicing location for the anticipated servicing event based, a least in part, on the servicing data, the one or more servicing attributes, and/or the simulation data.

In some implementations, the computing system can provide (e.g., via the optimization/planning system, scheduling system, simulation system, etc.) and/or obtain (e.g., via the servicing system) a vehicle request for one or more of the plurality of aerial vehicles for the performance of one or more anticipated, scheduled, simulated, etc. aerial transportation services during the operational time period. For example, the simulation data can be indicative of a first set of a plurality of aerial vehicles for providing one or more simulated flight itineraries at a respective time step of the operational time period. The first set of the plurality of aerial vehicles can include a number of aerial vehicles available for performing a transportation service at the respective time step. The vehicle request can be indicative of a second set of the plurality of aerial vehicles for providing one or more simulated flight itineraries at the respective time step of the operational time period. The second set of the plurality of aerial vehicles can include a number of aerial vehicle that are requested to be available at the respective time step. The second set can be different from the first set. For example, the second set can include a greater number of aerial vehicles (e.g., due to a higher than anticipated demand at a respective time step, etc.) than the first set of the plurality of aerial vehicles. As another example, the second set of the plurality of aerial vehicles can be less (e.g., due to a lower than anticipated demand at a respective time step, etc.) than the first set of the plurality of aerial vehicles.

The computing system (e.g., servicing system) can determine one or more servicing options based, at least in part, on the vehicle data, the servicing schedule, and/or the vehicle request. The one or more servicing options can be indicative of one or more modifications to the servicing schedule and/or one or more transportation services. In some implementations, each respective servicing option of the one or more servicing options can include contextual data indicative of the impact of the respective servicing option on one or more of the plurality of aerial vehicles (e.g., the availability of the aerial vehicle, the vehicle state of the aerial vehicle, etc.). For example, in the event the vehicle request includes a second set of vehicles greater than the first set of vehicles, each of the one or more servicing options can be indicative of one or more additional aerial vehicles, a component state of one or more components of each of the one or more additional aerial vehicles, and contextual data indicative of one or more mitigating performance factors associated with the plurality of aerial vehicles. The one or more mitigating performance factors can include one or more consequences of creating the availability of additional vehicles at a respective time step. The consequences can include, for example, a lower lifespan of one or more components of the vehicle, a consequential unavailability at another time step, an unavailability of another vehicle, etc.

By way of example, the one or more servicing options for creating additional availability can include taking a component from one uncharged vehicle to repair another charged vehicle to make the charged vehicle available at a respective time step. In such a case, the one or more servicing options can identify the charged and uncharged vehicle, a current component state of the replaceable component for each aerial vehicle, and the mitigating performance factor of reducing the availability of the uncharged vehicle. As another example, the one or more servicing options can include fast charging a power component for an aerial vehicle to make the vehicle available at the respective time step at the cost of the overall life span of the power component. In such a case, the one or more servicing options can identify a vehicle capable of fast charging, a current component state of the power component of the aerial vehicle, and the mitigating performance factor of a lower life span of the power component of the aerial vehicle.

In the event that the request includes a second set of vehicles less than the first set of vehicles, each of the one or more servicing options can be indicative of one or more aerial vehicles of the first set of the plurality of aerial vehicles, a component state of one or more components of each of the one or more aerial vehicles, and contextual data indicative of one or more positive performance factors associated with the one or more aerial vehicles. By way of example, the one or more servicing options can include slow charging a power component for an aerial vehicle to reduce the vehicle availability at a respective time step because it is no longer needed for the respective time step. In such a case, the one or more servicing options can identify a vehicle capable of slow charging, a current component state of the power component of the aerial vehicle, and the positive performance factor of increasing the life span of the power component of the aerial vehicle.

The computing system can provide the one or more servicing options (e.g., to the optimization/planning system, the scheduling system, simulation system, etc.). For example, the one or more servicing options can be provided for display, via one or more display devices, to one or more users of the computing system (e.g., one or more aerial transportation operators, schedulers, etc.). In such a case, each servicing option can be displayed with contextual data associated with the servicing option. The computing system (and/or user thereof) can select a servicing option from the one or more servicing options. The selection of the selected servicing option can be performed by the computing system, via a selection algorithm of the computing system, and/or by a user of the computing system, via user input. For example, the selection algorithm can include an automatic selection logic that selects a servicing option based on the contextual data accompanying the one or more servicing options. In addition, or alternatively, the computing system can receive user input indicative of a selection of the servicing option. The user input can be received via the one or more input devices (e.g., microphone, tactile device (e.g., keyboard, mouse, button, etc.), etc.) of the computing system.

The computing system (e.g., servicing system) can obtain (e.g., from the simulation system, the optimization/planning system, the scheduling system, and/or one or more users thereof) data indicative of a selection of at least one servicing option of the one or more servicing options. In response, the computing system can modify the servicing schedule and/or the one or more transportation services based, at least in part, on the at least one servicing option.

By way of example, the computing system can obtain data indicative of a selection of at least one servicing option of the one or more servicing options indicative of a change to at least one transportation service. The change to the transportation service can include a modification of a departure time for the transportation service, a modification of a destination location, a modification of flight capacity, and/or any other modification to the at least one transportation service. In response, the computing system can modify the transportation service based, at least in part, on the at least one servicing option. As one example, the computing system can modify a departure time for the transportation service to accommodate a charging service for a respective aerial vehicle assigned to perform the at least one transportation service. For instance, the computing system can identify (e.g., through the at least one servicing option) a charging advantage associated with the charging service for the respective aerial vehicle. The charging advantage, for instance, can be associated with an increase and/or decrease to the long-term health and/or a short-term health of an electric battery (e.g., as indicated by a respective vehicle model) of the respective aerial vehicle. Additionally, or alternatively, the charging advantage can include increased range of the aerial vehicle such that it could handle another flight to provide aerial transport and/or the arrival of an additional passenger to take an empty seat on the aerial vehicle. In such a case, the computing system can modify the departure time for the at least one transportation service to accommodate the charging service for the respective aerial vehicle based at least in part on the charging advantage.

The computing system can initiate the one or more modifications to the servicing schedule and/or the one or more transportation services by providing information indicative of the one or more modifications to one or more computing devices (e.g., facility devices, servicing devices, vehicle devices, vehicle provider devices, service provider devices, etc.) associated with the multi-modal transportation itinerary. The information indicative of the one or more modifications can include providing a notification to modify (e.g., postpone, advance, etc.) the departure of a transportation service, toggling the availability of one or more aerial vehicles associated with the modification(s), providing a notification indicative of a servicing event (and/or a modified (e.g., extended, reduced, etc.) servicing event) to a facility, servicing personnel, and/or any other device associated with the provision of the servicing event, and/or providing another notification indicative of the servicing event to the vehicle, vehicle provider, and/or any other device associated with the vehicle.

Example aspects of the present disclosure can provide a number of improvements to computing technology such as, for example, multi-modal transportation technology. For instance, the systems and methods of the present disclosure provide an improved approach for optimizing the real-time provisioning of multi-modal transportation itineraries over an operational time period. In particular, the systems and methods of the present disclosure can optimize the provisioning of multi-modal transportation itineraries over an operational time period by simulating a plurality of itineraries for each time step of the operational time period, ranking the plurality of simulated itineraries based on each itinerary's impact on one or more measures of the operational time period, and selecting a simulated multi-modal itinerary to perform based on the ranking. In addition, the systems and methods can determine a servicing schedule in view of the simulated itineraries that optimally anticipates and schedules servicing events throughout an operational time period to minimize the impact of a servicing event on the one or more measures of the operational time period. These improvements can be realized by utilizing simulation data indicative of future looking data simulated based on real world constraints representing the real world at a respective time step of an operational time period. By simulating the performance of a plurality of itineraries and selecting an itinerary and servicing event to schedule based on the simulated itineraries as disclosed herein, the systems and methods of the present disclosure can evaluate the overall impact of an itinerary or servicing event over an operational time period before the itinerary or event is scheduled. In this manner, the systems and methods of the present disclosure can enable a service entity to make wholistic and informed decisions on whether to schedule an itinerary and/or event. This, in turn, allows the systems and methods disclosed herein to generate multi-modal transportation itineraries that optimize one or more aspects of an operational time period, thereby reducing the computing resources expended providing multi-modal transportation services.

For example, a computing system can obtain data indicative of a request for a transportation service including at least an aerial transport for a rider of a multi-modal transportation service and simulation data indicative of a plurality of simulated flight itineraries at one or more time steps throughout an operational time period. The computing system can generate a multi-modal transportation itinerary for facilitating the aerial transport for the rider based, at least in part, on the one or more simulated flight itineraries. The multi-modal transportation itinerary can include at least a first transportation leg, a second transportation leg, and a third transportation leg. And, the computing system can provide the multi-modal transportation itinerary as an input for updating the plurality simulated flight itineraries.

In addition, or alternatively, the computing system can obtain vehicle data associated with a plurality of aerial vehicles and simulation data indicative of a plurality of simulated flight itineraries at one or more time steps throughout an operational time period. The vehicle data can be indicative of a component state of one or more components for each of the plurality of aerial vehicles. The plurality of simulated flight itineraries can be associated with at least one leg of a multi-modal transportation itinerary. The computing system can generate a servicing schedule for one or more anticipated servicing events during the operational time period based, at least in part, on the vehicle data and the simulation data. And, the computing system can output the servicing schedule. The computing system employs improved multi-modal transportation itineraries to optimally generate, schedule, maintain, and initiate multi-modal transportation services over an operational time period. To do so, the computing system accumulates and distributes newly available information such as, for example, the simulation data and the servicing data. By leveraging such data, the computing system can generate multi-modal transportation itineraries that maximize one or more measures of an operational time period over the operational time period.

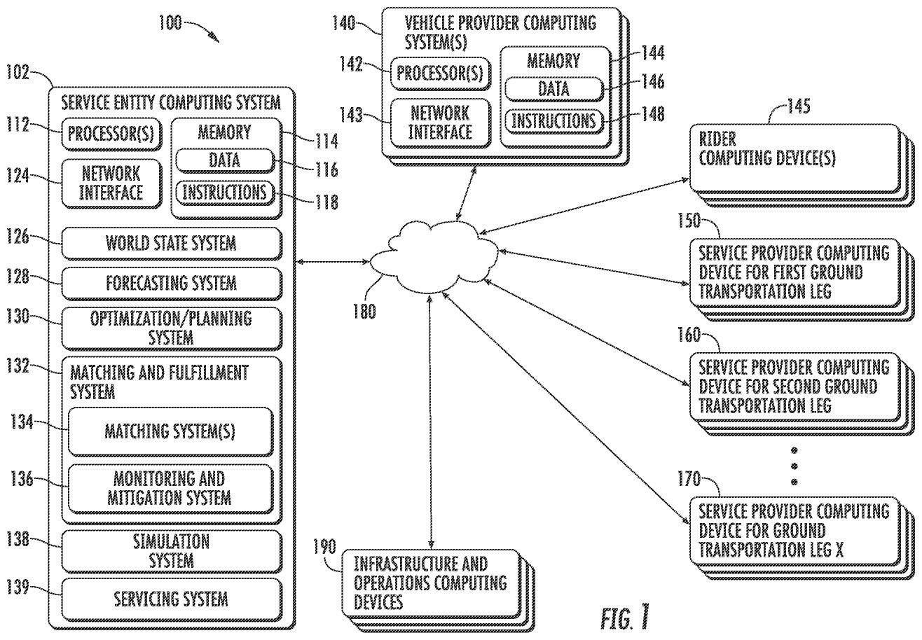

FIG. 1 depicts a block diagram of an example computing system 100 according to example embodiments of the present disclosure. The system 100 can include a service entity computing system 102 and a vehicle provider computing system 140 that can operate (e.g., collectively or individually) to control, route, monitor, and/or communicate with aircraft (e.g., VTOL aircraft) and/or one or more other transportation service entities to facilitate a multi-modal transportation service. These operations can be performed as part of a multi-modal transportation service for riders, for example, including travel by ground vehicle and travel by aircraft (e.g., VTOL aircraft).

The service entity computing system 102 can be communicatively connected over a network 180 to the vehicle provider computing system(s) 140, one or more rider computing devices 145, one or more service provider computing devices 150 for a first ground transportation leg, one or more service provider computing devices 160 for a second ground transportation leg, one or more service provider computing devices 170 for an Nth ground transportation leg, and/or one or more infrastructure and operations computing devices 190. For example, the vehicle provider computing system(s) 140 can include one or more communication interfaces 143 communicatively connected to the service entity computing system 102 and the service entity computing system 102 can include one or more communication interfaces 124 communicatively connected to the vehicle provider computing system(s) 140.

Each of the computing devices 145, 150, 160, 170, 190 can include any type of computing device such as a smartphone, tablet, hand-held computing device, wearable computing device, embedded computing device, navigational computing device, vehicle computing device, laptop, desktop, server system, etc. A computing device can be associated with a computing system. A computing device can include one or more processors and a memory (e.g., similar to as will be discussed with reference to processors 112, 142 and memory 114, 144). Although service provider devices are shown for N different transportation legs, any number of different transportation legs can be used, including, for example, less than the three illustrated legs (e.g., two legs can be used).

The computing systems 102, 140 can include one or more processors 112, 142 and a memory 114, 144. The one or more processors 112, 142 can be any suitable processing device (e.g., a processor core, a microprocessor, an ASIC, a FPGA, a controller, a microcontroller, etc.) and can be one processor or a plurality of processors that are operatively connected. The memory 114, 144 can include one or more non-transitory computer-readable storage media, such as RAM, ROM, EEPROM, EPROM, one or more memory devices, flash memory devices, etc., and combinations thereof.

The memory 114, 144 can store information that can be accessed by the one or more processors 112, 142. For instance, the memory 114, 144 (e.g., one or more non-transitory computer-readable storage mediums, memory devices) can store data 116, 146 that can be obtained, received, accessed, written, manipulated, created, and/or stored. In some implementations, the computing system(s) 102, 140 can obtain data from one or more memory device(s) that are remote from the system(s) 102, 140.

The memory 114, 144 can also store computer-readable instructions 118, 148 that can be executed by the one or more processors 112, 142. The instructions 118, 148 can be software written in any suitable programming language or can be implemented in hardware. Additionally, or alternatively, the instructions 118, 148 can be executed in logically and/or virtually separate threads on processor(s) 112, 142. For example, the memory 114, 144 can store instructions 118, 148 that when executed by the one or more processors 112, 142 cause the one or more processors 112, 142 to perform any of the operations and/or functions described herein.

The service entity computing system 102 can receive a request from a rider that requests for the service entity computing system 102 to facilitate a transportation service for the rider from an origin location to a destination location. For example, the rider can interact with a dedicated application on the rider computing device 145 (e.g., smartphone, tablet, wearable computing device, or the like) to initiate the request. By way of example, the rider can interact with the rider computing device 145 by opening the dedicated application and/or initiating a booking process via the dedicated application. The service entity computing system 102 can initiate the generation of a plurality of multi-modal transportation itineraries in response to the rider opening the dedicated application and/or otherwise initiating a booking process.

In response to the request, the service entity computing system 102 can generate at least one itinerary that includes transportation of the rider from the origin location to the destination location. Specifically, the service entity computing system 102 can generate an end-to-end multi-modal transportation itinerary including a plurality of transportation legs that include transportation via a plurality of different transportation modalities. The end-to-end multi-modal transportation itinerary can include two or more transportation legs that include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles. In some implementations, one or more vehicles can be provided by a vehicle provider so that the vehicle(s) can be utilized by the transportation platform for the provision of transportation services for one or more legs.

In some implementations, the service entity computing system 102 can facilitate the ability of the rider to receive transportation on one or more of the transportation legs included in the multi-modal transportation itinerary. As one example, the service entity computing system 102 can implement and/or interact with one or more ride-sharing networks (e.g., vehicle provider computing system(s) 140) to match a user with one or more transportation operators (e.g., service provider computing device(s) 150, 160, 170, etc.). As another example, the service entity computing system 102 can book or otherwise reserve a seat in, space on, or usage of one or more of the transportation modalities for the rider. Additionally, or alternatively, the service entity computing system 102 can collaborate with the vehicle provider computing system 140 to provide information for options to be provided by the vehicle provider computing system 140 for one or more of the transportation legs.

More particularly, the service entity computing system 102 can be associated with a service entity and be configured to manage, coordinate, and dynamically adjust a multi-modal transportation service via a transportation platform of the service entity. The service entity can include, for example, a transportation network provider. The transportation network provider can be an entity that coordinates, manages, etc. transportation services that include aerial and/or other types of vehicles. The transportation network provider can be associated with one or more transportation platforms. A transportation platform can be utilized for the provision of transportation services via one or more vehicles available, online, etc. to the transportation platform. In some implementations, the vehicles used to provide the transportation services can be owned, operated, leased, etc. by the service entity (e.g., the transportation network provider). Additionally, or alternatively, the vehicles used to provide the transportation service can be owned, operated, leased, etc. by an entity other than the service entity (e.g., a third party vehicle provider).

In some implementations, the service entity computing system 102 can respond to the rider's request for a transportation service by determining whether it is better to fulfill the rider's request using a single transportation modality or using multiple transportation modalities. As one example, the service entity computing system 102 can evaluate the rider's current location, origin location, and/or destination location to determine which modalities of transportation are usable at such location (e.g., able to access such locations). For example, the location(s) can be checked against a list of white listed locations that have been approved for participation in various types of modalities (e.g., flight modalities for the purpose of generating a multi-modal trip itinerary). As another example, the service entity computing system 102 can evaluate (e.g., generate) one or more itineraries that are single-modal and one or more itineraries that a multi-modal (e.g., inclusive of various combinations of different transportation modalities). The service entity computing system 102 can compare the generated single- and multi-modal itineraries to determine whether it is appropriate to suggest a single- or multi-modal itinerary to the rider. For example, one or more of the best itineraries (e.g., as evaluated based on various characteristics such as cost, time, etc.) can be suggested to the rider. The rider can select, via the rider computing device 145, one of the suggested itineraries to receive transportation services in accordance with the selected itinerary.

In some implementations, the service entity computing system 102 can continually re-evaluate various itineraries (e.g., single- and/or multi-modal itineraries) before and even during completion of a selected itinerary. If an improved itinerary becomes available (e.g., which may include changing from a single-modal itinerary to a multi-modal itinerary if, for example, a seat on a flight becomes available) the service entity computing system 102 can suggest the improved itinerary for selection by the rider. In some implementations, if the rider selects, via the rider computing device(s) 145, the improved itinerary during completion of an existing itinerary, the service entity computing system 102 can facilitate switching to the updated itinerary, including, for example, re-routing a service provider that is currently transporting the rider to an alternative, updated destination.

Thus, in response to the rider's request, the service entity computing system 102 can perform one or more algorithms to generate a multi-modal transportation itinerary for the rider. As an example, in some implementations, the service entity computing system 102 can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

As one particular example, in some implementations, the service entity computing system 102 can initially analyze a first transportation modality that is the most efficient (e.g., in terms of travel speed and/or cost) transportation modality which operates according to a fixed infrastructure. As an example, for most longer transportation services and for the mix of different modalities described above, flight modalities can both be the most efficient transportation modality (e.g., in terms travel speed/time) while also operating according to a fixed infrastructure. By first analyzing the most efficient transportation modality which operates according to a fixed infrastructure, the service entity computing system 102 can seek to identify an important transportation leg around which the remainder of the itinerary can be stitched.

More particularly, in some implementations, one or more of the transportation modalities can operate according to or within a fixed transportation infrastructure in which the ability of passengers to embark and disembark vehicles is constrained to a defined set of transportation nodes. As one example, in some implementations, aerial vehicles that operate within the ride sharing network can be constrained to load and unload passengers only at a defined set of physical take-off and/or landing areas which may in some instances be referred to as aerial transportation facilities. To provide an example, a large urban area may have dozens of transportation nodes located at various locations within the urban area. Each transportation node can include one or more landing pads and/or other infrastructure to enable passengers to safely embark or disembark from aerial vehicles. Transportation nodes can also include charging equipment, re-fueling equipment, and/or other infrastructure for enabling aerial operation. The take-off and/or landing areas of the transportation nodes can be located at ground level and/or elevated from ground-level (e.g., atop a building). The defined set of physical take-off and/or landing areas can include, for example, one or more public or private airports.

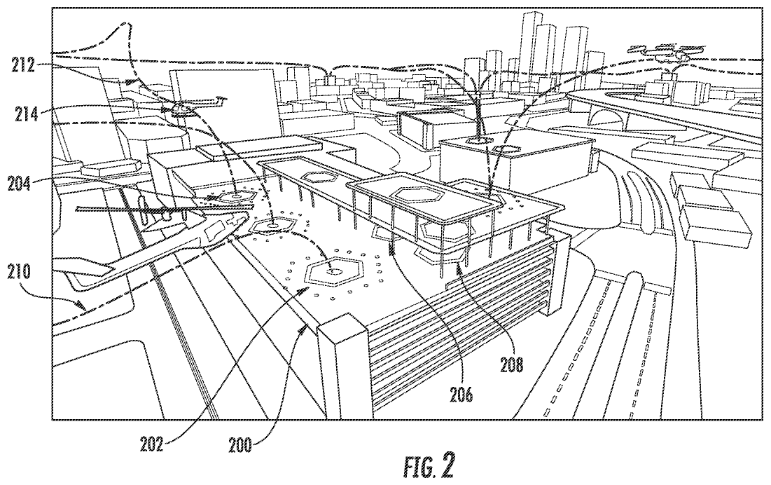

By way of example, FIG. 2 depicts a graphical diagram of an example transportation node according to example embodiments of the present disclosure. The example transportation node 200 can include a number of take-off/landing pads such as pads 202 and 204. In addition, the example transportation node 200 can include a number of vehicle parking locations such as parking locations 206 and 208. For example, re-fueling or re-charging infrastructure may be accessible at each parking location.

Flight trajectories into and out of the transportation node 200 can be defined, configured, assigned, communicated, etc. FIG. 2 illustrates a number of flight trajectories including, for example, trajectories 210 and 212. The trajectories can be fixed or can be dynamically computed. The trajectories can be computed by the aircraft or can be centrally computed and then assigned and communicated to the aircraft. As one example, FIG. 2 illustrates a helicopter 214 taking off from the pad 204 according to the trajectory 212.

The transportation node 200 includes a number of pads 202 and 204 and parking locations 206 and 208; however, it should be noted that the transportation nodes of the present disclosure can include a number of additional and/or alternative features for facilitating aerial transportation. A transportation node, for example, can include a number of charging locations, maintenance locations, passenger loading stations, etc. The charging locations can include re-fueling or re-charging infrastructure for a number of different aerial vehicle types and/or power component types as described herein. In addition, or alternatively, maintenance locations can include vehicle maintenance equipment for a number of different aerial vehicle types and/or power component types as described herein. In some implementations, a transportation node can be associated with one or more different aerial vehicle types (e.g., have compatible servicing equipment for, etc.) and/or specialize in one or more different aerial vehicle services. By way of example, a transportation node can be specialized in providing servicing events for one or more of a number of different aerial vehicle types and/or components thereof. As described in further detail herein, this information can be utilized by a servicing system to generate an optimized maintenance schedules.

Turning back to FIG. 1, the service entity computing system 102 can initially analyze the transportation modality that is the most supply-constrained. More particularly, certain transportation modalities may be more supply-constrained than other modalities in terms of number of available service providers and/or average number of services provided daily. For example, at least in the near future and due to the relatively larger challenge and cost involved with operating aerial vehicles, flight modalities are likely to be more supply-constrained than ground-based modalities such as cars. Because the most supply-constrained modality represents the most option-limiting aspect of building different itineraries, by first analyzing the most supply-constrained modality the service entity computing system 102 can more efficiently generate the multi-modal transportation itinerary.

The service entity computing system 102 can initially identify any fixed transportation nodes (e.g., aerial transportation facilities) associated with a transportation modality (e.g., aerial transportation modality) that are relevant to the rider's request. For example, the service entity computing system 102 can identify any nodes that are within a threshold distance from the origin location as candidate departure nodes. Likewise, the service entity computing system 102 can identify any nodes that are within a threshold distance from the destination location as candidate arrival nodes.

In some instances, the service entity computing system 102 may have at least some control over transportation services provided by service providers on at least some of the transportation modalities and, therefore, may pre-determine a number of planned transportation services by the service providers. For example, in some implementations, the operators of one or more aerial vehicles can be controlled by (e.g., contracted with) the service entity computing system 102. In such a case, the service entity computing system 102 can generate (e.g., on a daily basis) an initial pre-defined set of flight plans for service entity aerial vehicles and can add or remove passengers from each planned flight. In addition, the service entity computing system 102 can dynamically optimize planned transportation services by the service entity to account for real-time changes in rider availability and demand. For example, the service entity computing system 102 can dynamically modify the pre-determined flight plans (e.g., delay a planned flight departure by five minutes and/or change a planned flight to an alternative arrival transportation node).

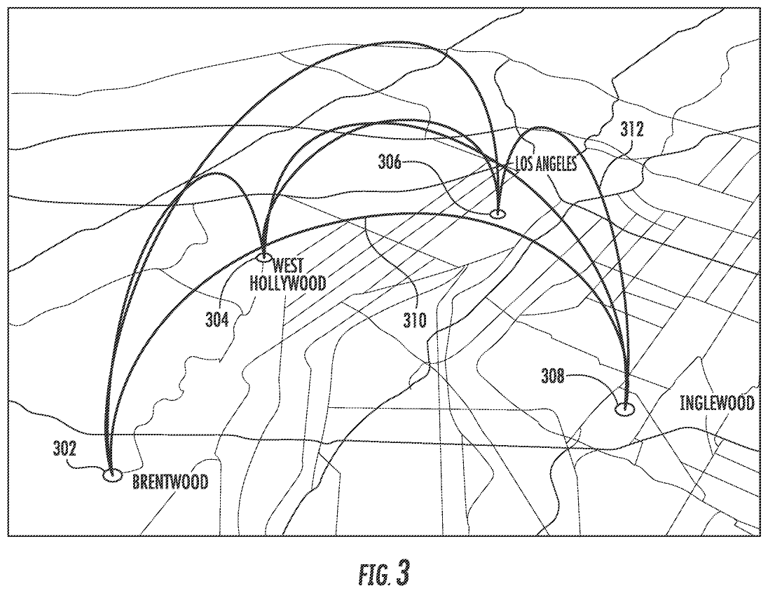

As an example, FIG. 3 depicts a graphical diagram of an example set of flight plans between an example set of transportation nodes according to example embodiments of the present disclosure. In particular, FIG. 3 provides a simplified illustration of an example fixed infrastructure associated with flight-based transportation in an example metropolitan area. As illustrated in FIG. 3, there can be four transportation nodes which may be referred to as “aerial transportation facilities.” For example, a first transportation node 302 is located in a first neighborhood of the metropolitan area, a second transportation node 304 is located in a second neighborhood, a third transportation node 306 is located in a third neighborhood, and a fourth transportation node 308 is located in a fourth neighborhood. The location and number of transportation nodes is provided only as an example. Any number of transportation nodes at any different locations can be used.

Flights can be available (e.g., may be pre-planned, dynamically planned, etc.) between certain pairs of the transportation nodes. For example, a flight path 310 can exist between the first transportation node 302 and the fourth transportation node 308. Likewise, a flight path 312 can exist between the fourth transportation node 308 and the third transportation node 306.

Turning back to FIG. 1, service entity computing system 102 can identify a set of candidate transportation plans that can form the basis for building a set of potential itineraries. As described in further detail herein, the set of candidate transportation plans can include each possible transportation itinerary between each node of the fixed transportation infrastructure at a respective time. The service entity computing system 102 can stitch additional transportation legs to each respective candidate transportation plan to generate a plurality of candidate end-to-end itineraries. The service entity computing system 102 can analyze the candidate itineraries to select one or more itineraries that are high quality according to various measures. The service entity computing system 102 can interact with one or more vehicle provider computing system(s) 140 and/or service provider computing device 150, 160, 170 to facilitate at least one of the one or more multi-modal transportation itineraries.

In addition, or alternatively, the service entity computing system 102 can obtain a set of candidate transportation plans from a vehicle provider computing system 140. The service entity computing system 102, for example, can collaborate with the vehicle provider computing system 140 to obtain a set of candidate aerial transportation services. For example, the system 100 can include one or more vehicle provider computing systems 140. The vehicle provider computing system(s) 140 can be associated with one or more vehicle providers. A vehicle provider can be an entity (e.g., a first party entity, third party entity, etc.) that operates, owns, leases, controls, manufactures, etc. one or more vehicles. For example, a vehicle provider can include an operator, vendor, supplier, manufacturer, etc. of one or more aircraft. Each vehicle provider can be associated with respective vehicle provider computing system(s) 140. The vehicle provider computing system(s) 140 can be configured to manage the vehicles associated with that vehicle provider. This can include, for example, overseeing itineraries, accepting/rejecting transportation services, suggesting candidate vehicles, overseeing maintenance, controlling online/offline status, etc.

A vehicle provider computing device 140 can communicate with the service entity computing system 102 directly and/or indirectly. A vehicle associated with a vehicle provider can communicate directly with the service entity computing system 102 and/or indirectly via the vehicle provider computing system(s) 140 (e.g., acting as an intermediary, etc.). For instance, the vehicle provider computing system 140 can include one or more communication interfaces 143 communicatively connected to the service entity computing system 102 such that the vehicle provider computing system 140 can exchange information to collaboratively generate and facilitate multi-modal transportation services.

For example, the service entity computing system 102 and the vehicle provider computing system(s) 140 can communicate information to one another. The vehicle provider computing system(s) 140 can communicate various types of information to the service entity computing system 102. For example, the vehicle provider computing system(s) 140 can provide data indicative of: status information (e.g., online/offline status, on-trip status, vehicle availability for transportation service, etc.), acceptance and/or rejection of a service (e.g., an aerial transportation service, etc.), maintenance information, vehicle parameters (e.g., weight capacity, noise signature, number of seats, set configuration, flight hours, charging/refueling parameters, hardware, temperature control parameters, operational restrictions, etc.), flight schedules, candidate vehicles, locations, updates of any such information, etc. The service entity computing system 102 can communicate various types of information to a vehicle provider system(s) 140. For example, the service entity computing system 102 can provide data indicative of: transportation services (e.g., services needed, specific vehicle requests, etc.), vehicle itineraries, status information (e.g., service in progress, etc.), vehicle parameter updates, payloads, locations, user/passenger information (e.g., anonymized and securely protected, etc.), air traffic information, environmental data (e.g., expected wind speeds, weather information, etc.), and/or other types of information.

As discussed herein, the service entity associated with the service entity computing system 102 can utilize vehicles associated with various parties. The vehicles to be utilized for a particular multi-modal transportation service can be determined in a variety of manners. The service entity computing system 102 (and the associated service entity) may have varying levels of control over the vehicle(s) that perform its services. For example, a vehicle provider may make one or more vehicles available to the service entity. The service entity may be able to determine which vehicles are to perform which legs of a transportation without input from the vehicle provider. Thus, the service entity may have full control of the vehicles online with the platform.

In some implementations, the service entity may determine transportation service assignments for vehicles of the service entity, while a vehicle provider may be able to determine (e.g., accept, reject, etc.) transportation service assignments for its vehicles. For example, the service entity computing system 102 can provide data indicative of a flight leg, itinerary, etc. to one or more vehicle provider computing devices 140. The data can indicate a request for a specific vehicle or a request for any available vehicle within the vehicle provider's available fleet to perform the transportation service (e.g., flight transportation between two vertiports, etc.). In some implementations, the data may include certain parameters (e.g., weight capacity, number of seats, noise parameters, etc.) needed and/or preferred by the service entity, user, etc. The vehicle provider computing device 140 can process this data and determine whether a specifically requested vehicle and/or another vehicle associated with the vehicle provider will provide the requested service (e.g., perform a flight for the second leg of a multi-model transportation service). The vehicle provider computing device 140 can communicate data indicative of the acceptance or rejection to the service entity computing system 102. In some implementations, data indicative of the requested transportation service can be communicated to a service provider computing device 150, 160, 160 associated with a vehicle of a vehicle provider's fleet (e.g., an aircraft, etc.) and the service provider can accept or reject the service (e.g., the flight transportation, etc.).

In some implementations, one or more vehicle provider computing system(s) 140 can communicate data indicative of a plurality of candidate vehicles that could provide the requested service (e.g., perform an aerial transportation service for a flight leg). The service entity computing system 102 can select from among the plurality of candidate vehicles and communicate data indicative of the selected candidate vehicle to the vehicle provider computing system(s) 140.

The service entity computing system 102 can determine which vehicles are to perform which transportations legs in an on-demand manner or based at least in part on a schedule. For example, service entity computing system 102 can initially generate a flight itinerary in response to receiving a first request. In some implementations, the service entity computing system 102 can have a pre-determined flight schedule and offer aerial transport (e.g., for multi-modal transportation services, etc.) in the event that a user's time constraints and locations can be met with the pre-determined flight schedule.

In some implementations, the vehicle provider may provide initial input regarding vehicle scheduling. For example, the vehicle provider computing system 140 can communicate data indicative of a flight schedule for one or more aircrafts between various vertiports. The vehicle provider system 140 can communicate initial seat availability, as well as updates throughout an operational time period (e.g., throughout a day, etc.), to the service entity computing system 102. The service entity computing system 102 can utilize this flight schedule to determine itineraries for users and/or vehicles of the transportation service. For example, the service entity computing system 102 can use the flight schedule to determine whether to offer a multi-modal transportation service with an aerial leg to a user and/or to generate itineraries with aerial legs based on the flight schedule. In some implementations, the flight schedule can be an initial flight schedule for an operational time period. For example, the vehicle provider computing system(s) 140 can provide data indicative of the initial flights for the available vehicles at the beginning of a day. The service entity computing system 102 can utilize this data to determine multi-modal transportation services at the beginning of the day. Thereafter, the service entity computing system 102 can determine the flight itineraries in an on-demand manner to meet user/passenger demand throughout the operational time period.

Additionally, or alternatively, the service entity computing system 102 can communicate data indicative of a schedule (e.g., initial, for full operational period, etc.) to the vehicle provider computing system(s) 140. The vehicle provider computing system(s) 140 can process the schedule and communicate data indicative of which vehicles (e.g., aircraft, etc.) are available for which services (e.g., flight legs, etc.).

In some implementations, the service entity computing system 102 can communicate data indicative of a transportation service (e.g., one or more flight legs, schedules, etc.) to a plurality of vehicle provider computing system(s) 140. One or more of the vehicle provider computing system(s) 140 can process the data and communicate data indicative of vehicle(s) (e.g., aircraft, etc.) that are available to fulfill the transportation service (e.g., perform aerial transportation for one or more leg(s), etc.) to the service entity computing system 102. In some implementations, the vehicle provider computing system(s) 140 can provide information indicative of vehicle parameters, costs/fees, etc. The service entity computing system 102 can be configured to analyze the responses from the plurality of vehicle provider computing systems 140 to determine a service provider. For example, the service entity computing system 102 can utilize rules, models, algorithms, etc. that weigh the various vehicle parameters to select an aircraft for a user to ensure that the user's estimated arrival times are not violated, to minimize costs, etc.

The vehicle provider computing system(s) 140 and/or the service entity computing system 102 can communicate data indicative of the transportation service (e.g., flight itinerary data, etc.) to a service provider computing device 150, 160, 170, associated with a vehicle. For example, a vehicle provider system 140 or the service entity computing system 102 can communicate data indicative of a flight (e.g., times, locations, users, payload, etc.) to a computing device onboard an aircraft and/or a device of a pilot of the aircraft.

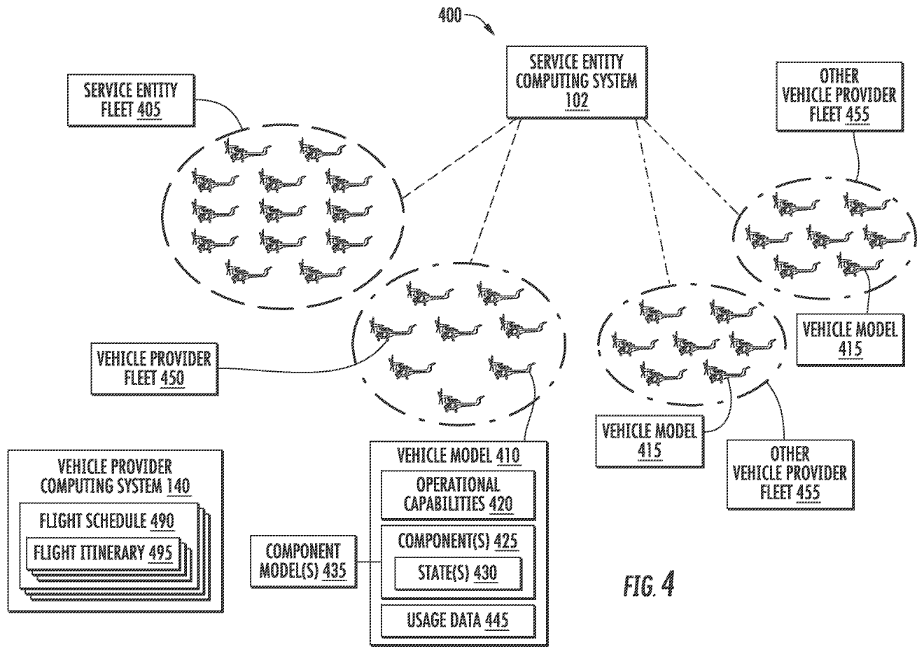

FIG. 4 depicts an example vehicle provider ecosystem 400 according to example embodiments of the present disclosure. The service entity computing system 102 can utilize service entity vehicle(s) of the service entity fleet 405 and/or one or more vehicle(s) from one or more third-party aerial vehicle provider(s) fleets 450, 455 to perform one or more aerial transportation services (e.g., throughout an operational time period such as an hour, day, week, etc.). The number of aerial vehicles available from the one or more third-party aerial vehicle providers (e.g., vehicle provider associated with vehicle provider computing system 140) can be independently available to a plurality of different ride-sharing platforms.

For example, a vehicle provider (e.g., associated with vehicle provider computing system 140) and/or the other aerial vehicle providers can be associated with a vehicle provider fleet 450 and/or a respective other vehicle provider fleet 455. Each fleet 450, 455 can include one or more aerial vehicles associated (e.g., managed, operated, scheduled, etc.) with a respective vehicle provider. The aerial vehicle(s) can include one or more autonomous, semi-autonomous, and/or non-autonomous aerial vehicles. The vehicle(s) can include any type of aircraft such as, for example, helicopters and/or other vertical take-off and landing aircraft (VTOL) including electric vertical take-off and landing aircraft (eVTOL). For instance, the vehicles can include one or more electric vehicles such as, for example, electric vertical and take-off and landing vehicles. The electric vehicles can be powered by one or more electric batteries.

The vehicle provider computing system 140 can be configured to manage, maintain, and/or schedule the fleet of aerial vehicles 450, 455 across a plurality of aerial transportation facilities based on information associated with the vehicles. In addition, or alternatively, the service entity computing system 102 can be configured to manage, maintain, and/or scheduled the fleet of aerial vehicles 450, 455. For example, in some implementations, the service entity computing system 102 can perform one or more of the functions of the vehicle provider computing system 140 as described herein.

By way of example, the service entity associated with the service entity computing system 102 can utilize vehicles associated with various third parties. In some implementations, the service entity can also be a vehicle provider (e.g., a first party entity, etc.). For example, the service entity 102 can utilize vehicles (e.g., ground-based vehicles, aircraft, etc.) within the service entity's fleet 405 that are online with the transportation platform, etc. Additionally, or alternatively, the service entity can utilize vehicles provided by a vehicle provider 140 from the vehicle provider's fleet 450, 455. A fleet 450, 455 can include one or a plurality of vehicles. A vehicle provider 140 can make one or more of the vehicles in its fleet 450, 455 available to the service entity/service entity computing system 102. For example, the vehicle provider computing system(s) 140 and/or a service provider computing device of a vehicle can log into a transportation platform, provide data indicating a vehicle is available, facilitate the vehicle being actively engaged with the transportation platform, and/or otherwise inform a service entity of a vehicle's availability. In some implementations, a vehicle provider computing device 140 can provide data indicative of vehicles that are not online with the service entity and that could or may become available.

The vehicles that are available for transportation services can include one or more types of vehicles. For example, the vehicle provider(s) 140 can include a plurality of aerial vehicle providers, where each vehicle provider can provide a different type of aircraft (e.g., VTOL, helicopter, etc.) and/or a different model of aircraft. In some implementations, a vehicle provider can provide more than one type, version, model, etc. of aircraft available for the service entity computing system 102 and/or the service entity. The different types of aircraft can include different shapes, sizes, capacities, capabilities, parameters, autonomy abilities (e.g., autonomous, semi-autonomous, manual, etc.), landing gear, hardware, etc. Although the following describes vehicle providers as aerial vehicle providers, this is provided as an example only and is not intended to be limiting. For example, vehicle providers can include providers of other types of vehicles such as ground-based vehicles (e.g., cars, bicycles, scooters, etc.) and/or other modes of transportation.

As described in further detail below, the fleet of aerial vehicles can be associated with one or more vehicle models 410, 415. The vehicle models 410, 415 can be indicative of one or more aerial vehicle operational capabilities 420, vehicle components 425, and/or usage data 445 associated with each vehicle of the fleet of aerial vehicles 450, 455. The vehicle components 425 can be associated with one or more component states 430 and/or component models 435.

The vehicle provider computing system 140 can determine one or more flight schedule(s) 490 for one or more vehicles of the fleet of aerial vehicles 450. Each flight schedule can include one or more flight itineraries 495 for each vehicle of the fleet of aerial vehicles 450. A flight itinerary 495, for example, can include one or more flight attributes. The one or more flight attributes can include a departure time, a departure location (e.g., the aerial transportation facility, a take-off location of the aerial transportation facility, etc.), a destination time (e.g., estimated time of arrival at a destination facility), a destination location, a vehicle capacity (e.g., number of passengers, etc.), a vehicle operator associated with the aerial transportation leg and/or any other information associated with the provision of an aerial transportation service.

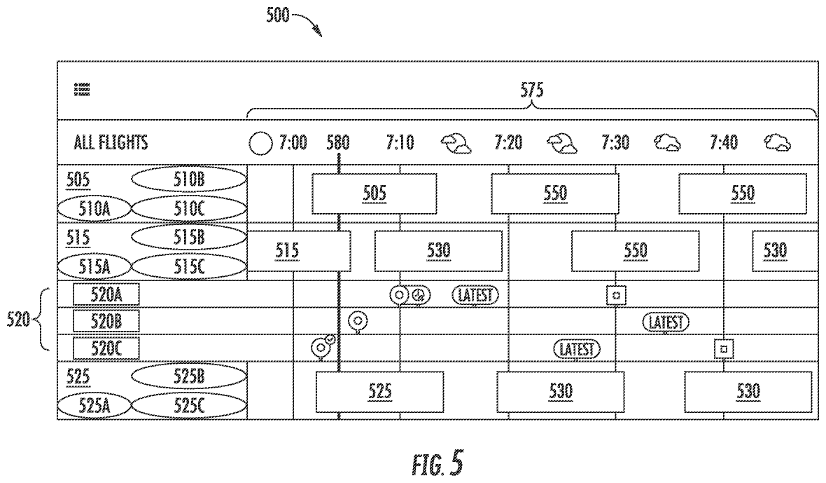

FIG. 5, for example, depicts an example operations schedule 500 according to example embodiments of the present disclosure. The operations schedule 500 can include a plurality of flight itineraries 505, 515, 525, 530 and servicing events 550 throughout an operational time period 575. The plurality of flight itineraries 505, 515, 525, 530 can include one or more current flight itineraries 505, 515, 525 and/or one or more future itineraries 530. The one or more current flight itineraries 505, 515, 525 can begin (e.g., board), progress (e.g., take-off, fly, land, etc.), and/or end (e.g., deboard) at a current time step 580 of the operational time period 575. The one or more future flight itineraries 530 can begin, progress, and/or end at a future time step subsequent to the current time step 580.

Each flight itinerary 505, 515, 525, 530 can include a plurality of attributes 510A-C, 515A-C, 525A-C. The plurality of attributes 510A-C, 515A-C, 525A-C can include a departure/destination location 510A, a vehicle capacity 510B, and/or a current status 510C (e.g., boarding, taking-off, en-route, landing, deboarding, etc.). In addition, the flight itineraries 505, 515, 525, 530 can include a passenger manifest 520. The passenger manifest 520 can include a list of passengers 520A-C and/or one or more passenger attributes associated with each of the passengers 520A-C. The one or more servicing events 550 can include a scheduled event for servicing an aerial vehicle. Servicing an aerial vehicle can include refueling, recharging, and/or repairing one or more components of the aerial vehicle.

Each servicing event 550 can include one or more servicing attributes. The one or more servicing attributes can include an aerial vehicle identifier, a servicing type, and/or an estimated time or infrastructure for performing the servicing event 550. The aerial vehicle identifier can identify an aerial vehicle associated with the servicing event 550. For example, the aerial vehicle identifier can include an aerial vehicle identification number (e.g., serial number, registration number, etc.), a tail number, and/or any other number or text unique to a respective aerial vehicle (e.g., of the plurality of aerial vehicles that operate within the ride sharing network facilitated by a computing system, etc.). The servicing type can be indicative of a type (e.g., refueling, recharging, repairing, etc.) of service to be performed on the aerial vehicle. For example, the servicing types can identify whether the servicing event 550 is associated with refueling the aerial vehicle and/or repairing one or more components of the aerial vehicle. As an example, the servicing type can be associated with a component (e.g., climate control component, flight control component (e.g., rotor, blade, windshield, etc.), etc.) of the aerial vehicle. The estimated time and/or infrastructure for performing the servicing event 550 can include an estimated time (e.g., average time for fueling/charging a vehicle, etc.) and/or a required infrastructure (e.g., charging interfaces/materials, fueling interfaces/materials, other tools, interfaces, and/or materials for repairing one or more components of the aerial vehicle) for completing a servicing event 550 of a certain type.

Turning back to FIG. 1, in scenarios in which the aerial transportation modality operates according to a scheduled itinerary as described with reference to FIG. 4, after identifying relevant fixed transportation nodes associated with a multi-modal transportation service from an origin location to a destination location, the service entity computing system 102 can obtain one or more candidate flight itineraries associated with the multi-modal transportation service (e.g., the origin and/or destination location). The one or more candidate flight itineraries, for example, can include the flight schedules for each relevant fixed transportation node of the multi-modal transportation service. The service entity computing system 102 can obtain the one or more candidate flight itineraries to identify candidate transportation plans between the relevant nodes. In some implementations, for example, the vehicle provider computing system 140 can provide a flight schedule (e.g., for each aerial vehicle, for each of the relevant nodes, etc.) to the service entity computing system 102. Additionally, or alternatively, the service entity computing system 102 can generate a flight schedule (e.g., for each vehicle, for each of the relevant nodes, etc.). The service entity computing system 102 can be configured to generate one or more multi-modal transportation itineraries based, at least in part, on the flight schedules and multi-modal transportation data. For example, the service entity computing system 102 can identify any transportation plans between one of the candidate departure nodes and one of the candidate arrival nodes which would satisfy the rider's request, including, for example, any departure or arrival time requests. The service entity computing system 102 can stitch one or more additional legs to a respective transportation plan to generate a multi-modal transportation itinerary.

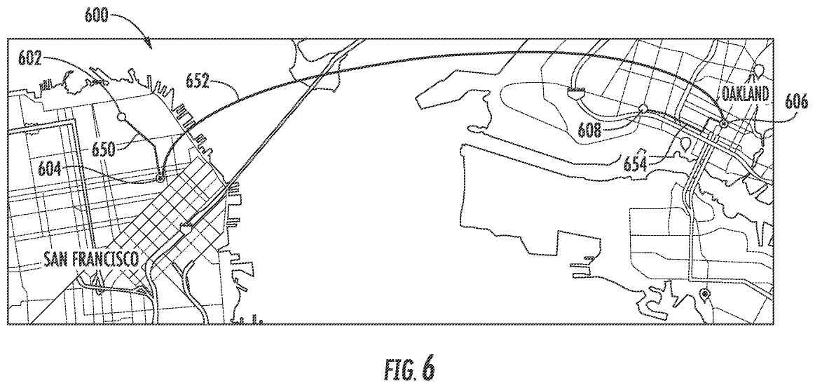

By way of example, FIG. 6 depicts a graphical diagram of an example multi-modal transportation service itinerary 600 according to example embodiments of the present disclosure. The multi-modal transportation itinerary 600 can include three transportation legs to transport the rider from an origin 602 to a destination 608. In particular, the multi-modal transportation itinerary 600 can include a first, ground-based (e.g., car-based) transportation leg 650 which transports the rider from the origin 602 to a departure transportation node 604; a second, flight-based transportation leg 652 which transports the rider from the departure transportation node 604 to an arrival transportation node 606; and a third, ground-based (e.g., car-based) transportation leg 654 which transports the rider from the arrival transportation node 606 to the destination 608. More particularly, the multi-modal transportation itinerary 600 can include a first ground transportation leg 650 from the origin location 602 to a first aerial transportation facility 604, an aerial transportation leg 652 from the first aerial transportation facility 604 to a second aerial transportation facility 606, and a second ground transportation leg 654 from the second aerial transportation facility 606 to the destination location 608. The aerial transportation leg 652 can include a selected plan (e.g., flight itinerary) of one or more candidate flight itineraries obtained from the vehicle provider computing system.

Turning back to FIG. 1, the service entity computing system 102 can include a number of different systems such as a world state system 126, a forecasting system 128, an optimization/planning system 130, a matching and fulfillment system 132, a simulation system 138, and/or a servicing system 139 that can help plan and fulfill one or more portions of a multi-modal transportation service. The matching and fulfillment system 132 can include a different matching system 134 for each transportation leg and a monitoring and mitigation system 136. Each of the systems 126-139 can be implemented in software, firmware, and/or hardware, including, for example, as software which, when executed by the processors 112 cause the service entity computing system 102 to perform desired operations. The desired operations, for example, can provide one or more backend services of the service entity computing system 102 to the one or more vehicle provider computing system(s) 140 and/or other associated devices 145, 150, 160, 170, 190. For example, the world state system 126 can provide a backend world state service. The forecasting system 128 can provide a backend forecasting service. The optimization/planning 130 system can provide a backend routing service. The matching and fulfillment system 132 can provide a matching and monitoring service. The simulation system 138 can provide a simulation service. And, the servicing system 139 can provide a servicing service. The systems 126-139 can cooperatively interoperate (e.g., including supplying information to each other).

The world state system 126 can operate a state monitoring service to maintain data descriptive of a current state of the world. For example, the world state system 126 can generate, collect, and/or maintain data descriptive of planned itineraries; pre-determined transportation plans (e.g., flight plans) and assignments; current requests; current ground transportation service providers; current aerial transport facility operational statuses (e.g., including re-charging or re-fueling capabilities); current aerial vehicle statuses (e.g., including current fuel or battery level); current pilot statuses; current flight states and trajectories; current airspace information; current weather conditions; current communication system behavior/protocols; and/or the like. For instance, the world state system 126 can be configured to obtain world state data through communication (e.g., via an API platform) with one or more vehicles (e.g., via service provider device(s) 150, 160, 170), vehicle providers (e.g., vehicle provider computing system(s) 140), and/or any other transportation entity associated with the service entity computing system 102.

As another example, the forecasting system 128 can operate a forecasting service to generate predictions of transportation demand, weather forecasts, and/or any other future looking data helpful for completing a transportation service. The forecasting system 128 can generate predictions of the demand and supply for transportation services at or between various locations over time. The forecasting system 128 can also generate or supply weather forecasts. The forecasts made by the system 128 can be generated based on historical data and/or through modeling of demand and supply.

The optimization/planning system 130 can generate transportation plans for various transportation assets and/or can generate itineraries for riders. For example, the optimization/planning system 130 can perform and/or facilitate flight planning. As another example, the optimization/planning system 130 can plan or manage/optimize itineraries which include interactions between riders and service providers or vehicle providers across multiple modes of transportation. The matching and fulfillment system 132 can match a rider with a service provider for each of the different transportation legs. For example, each respective matching system 134 can communicate with the corresponding service provider computing devices 150, 160, 170 via one or more APIs or connections. Each matching system 134 can communicate trajectories and/or assignments to the corresponding service providers or vehicle providers. Thus, the matching and fulfillment system 132 can perform or handle assignment of ground transportation, flight trajectories, take-off/landing, etc.

The monitoring and mitigation system 136 can perform monitoring of rider itineraries and can perform mitigation when an itinerary is subject to significant delay (e.g., one of the legs fails to succeed). Thus, the monitoring and mitigation system 136 can perform situation awareness, advisories, adjustments and the like. The monitoring and mitigation system 136 can trigger alerts and actions sent to the systems 140 or devices 145, 150, 160, 170, and 190. For example, entities such as riders, service providers, and/or operations personnel can be alerted when a certain transportation plan has been modified and can be provided with an updated plan/course of action. Thus, the monitoring and mitigation system 136 can have additional control over the movement of aerial vehicles, ground vehicles, air traffic controllers, pilots, and riders.

The infrastructure and operations computing devices 190 can be any form of computing device used by or at the infrastructure or operations personnel including, for example, devices configured to perform passenger security checks, luggage check in/out, re-charging/re-fueling, vehicle climate control, safety briefings, vehicle check in/out, and/or the like.

The network(s) 180 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc.

To help optimize multi-modal transportation services provided throughout an operational time period, the service entity computing system 102 (e.g., simulation system 138) can generate and initiate a number of simulation instances for each time step of an operational time period. The operational time period, for example, can include any unit of time during which transportation services and/or servicing services can be provided. By way of example, the operational time period can include one or more hours, days, weeks, etc. of operations. The simulation instances can be utilized by the service entity computing system 102 and/or provided to the vehicle provider computing system 140 to facilitate the scheduling, fulfillment, and modification of transportation services during the operational time period.

More particularly, the service entity computing system 102 can include a simulation system 138 that can provide a simulation service. The simulation service can generate a plurality of simulation instances based on real-world conditions. Each simulation instance can include a simulated flight itinerary (and/or a simulated end-to-end multi-modal transportation itinerary including the simulated flight itinerary as at least one leg) performed in a simulated world environment representing one or more constraints (e.g., demand constraints, vehicle constraints, weather constraints, etc.) of the real world at a respective time step. For example, the simulated world environment at a current time step can represent the current state of the real world as maintained by the world state system 126. The simulated world environment at a respective time step subsequent to the current time step can represent a predicted state of the real world as determined by the forecasting system 128. Simulated itineraries generated for the respective time step subsequent to the current time step can be determined and simulated based on a simulated itinerary generated for the current time step and the predicted state of the real world at the respective time step. In this manner, the number of simulated itineraries can illustrate the impact that a simulated itinerary at a current time step can have on a number of subsequent itineraries (and/or an availability thereof). By obtaining simulation data indicative of a plurality of simulated itineraries for the operational time period, the service entity computing system 102 (e.g., the optimization/planning system 130) can generate a multi-modal transportation itinerary for a current and/or future time step based on future insights provided by the simulation data. In addition, or alternatively, the simulation data can be provided to the vehicle provider computing system 140 for the purpose of generating one or more candidate aerial transportation plans for a multi-modal transportation itinerary.

As one example, the service entity computing system 102 (e.g., optimization/planning system 130) can receive multi-modal transportation data indicative of one or more requests for a plurality of transportation services and generate the plurality of multi-modal transportation itineraries for facilitating the plurality of transportation services. An aerial vehicle can be assigned (e.g., by the service entity computing system 102, the vehicle provider computing system 140, etc.) to provide at least one leg of the multi-modal transportation itinerary. For example, the multi-modal transportation itinerary can include at least one aerial transportation leg. The aerial vehicle can be assigned to provide the at least one aerial transportation leg. The service entity computing system 102 (e.g., matching and fulfillment system 132) and/or the vehicle provider computing system 140 can schedule, track the progress of, and/or modify each of the plurality of multi-modal transportation itineraries and/or one or more transportations legs (e.g., the at least one aerial transportation leg) thereof during operational time period. A modification, for example, can include a modification to a flight schedule generated and maintained by the service entity computing system 102 and/or a modification to a flight schedule generated and maintained by the vehicle provider computing system 140. For example, the service entity computing system 102 can generate a new multi-modal transportation itinerary, modify at least one of the plurality of multi-modal transportation itineraries, request the modification of at least one of the plurality of multi-modal transportation itineraries, and/or receive the modification of at least one of the plurality of multi-modal transportation itineraries based on the progress of each of the multi-modal transportation itineraries and/or additional multi-modal transportation data (e.g., indicative of one or more additional requests, etc.).

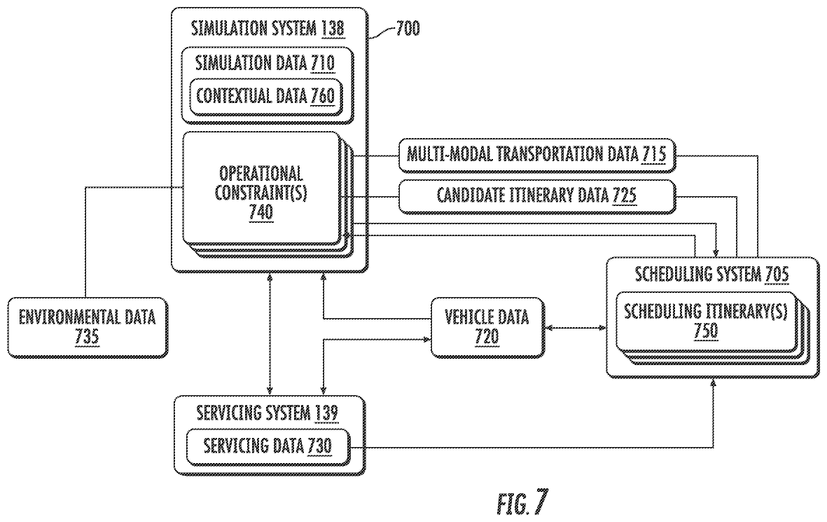

At times, the generation and/or modification of one multi-modal transportation itinerary can negatively affect one or more potential future itineraries. The computing system(s) 102, 140 can leverage the future insights provided by the simulation data to optimize each scheduled and/or modified multi-modal transportation itinerary over the operational time period. By way of example, FIG. 7 depicts a data flow diagram 700 for utilizing simulation data to facilitate a multi-modal transportation service according to example embodiments of the present disclosure. As depicted, a scheduling system 705 can interact with a simulation system 138 and/or servicing system 139 to determine one or more scheduled itineraries 750. The one or more scheduled itineraries can include one or more multi-modal transportation itineraries and/or one or more transportation legs (e.g., an aerial transportation leg) of a multi-modal transportation itinerary.

The scheduling system 705 can include the service entity computing system 102 and/or the vehicle provider computing system 140 of FIG. 1. For example, the scheduled itineraries 750 can include one or more flight itineraries, and the service entity computing system 102 can generate one or more multi-modal transportation itineraries based on the one or more scheduled itineraries 750. The one or more scheduled itineraries 750 can be generated by the service entity computing system 102 and/or provided by the vehicle provider computing system 140. In the event that the one or more scheduled itineraries 750 are provided by the vehicle provider computing system 140, the service entity computing system 102 (e.g., simulation system 138, servicing system 139, etc.) can provide data such as, for example, simulation data 710, multi-modal transportation data 715, servicing data 730, and/or any other data described herein to the vehicle provider computing system 140. The vehicle provider computing system 140 can leverage the data provided by the service entity computing system 102 to generate the scheduled itineraries 750 as described herein.

For example, simulation data 710 can be generated (e.g., by a simulation computing system 138) based on multi-modal transportation data 715, vehicle data 720, candidate itinerary data 725, servicing data 730, environmental data 735, and/or any other data indicative of the current and/or future state of the world. As an example, the multi-modal transportation data 715 can include one or more anticipated, real-time, and/or scheduled requests for an aerial transportation service. For instance, the one or more requests can include one or more real-time requests received at a current time step, one or more scheduled requests received at a time step preceding the current time step and assigned to a scheduled multi-modal transportation itinerary, and/or one or more anticipated requests (e.g., an anticipated demand for multi-modal transportation services). The one or more anticipated requests can include an estimated number of requests that will be received at one or more time steps throughout the operational time period.

The multi-modal transportation data 715 can include demand data indicative of a plurality of anticipated requests and/or one or more aspects thereof. For instance, the demand data can be indicative of the one or more anticipated transportation services throughout the operational time period. By way of example, the service entity computing system 102 can include a network model configured to predict the plurality of anticipated requests based on historical and/or real-time data.

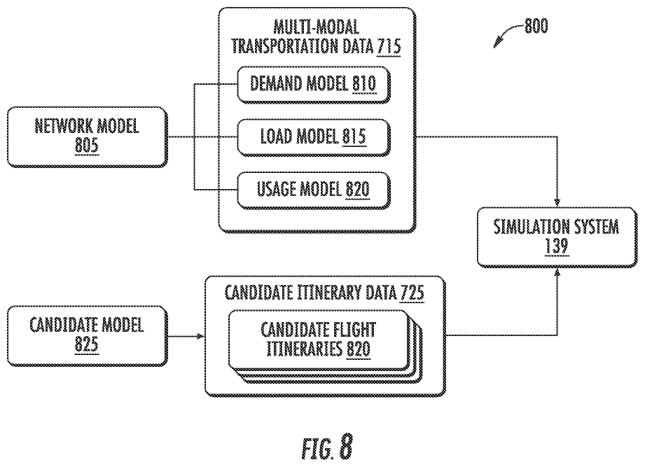

For example, FIG. 8 depicts a data flow diagram 800 for generating example operational constraints such as the multi-modal transportation data according to example embodiments of the present disclosure. As depicted, the network model 805 can include a demand model 810, a load model 815, and/or an aerial transport usage model 820. The demand model 810 can be configured to determine an anticipated demand for aerial transportation services at one or more time steps throughout the operational time period. The load model 815 can be configured to estimate the maximum expected load factors at one or more time steps throughout the operational time period. A load factor, for example, can identify a total expected weight to be transported. The aerial transport usage model 820 can be configured to estimate an expected number of flights for each aerial transport facility and/or aerial vehicle of the fixed transportation infrastructure at one or more time steps throughout the operational time period. For example, the aerial transportation usage model 820 can identify an expected number of aerial vehicles that will land, park, receive servicing, and/or take off from each of a plurality of aerial transport facilities.

In some implementations, the network model 805 and/or each of the sub models 810, 815, 820 can include one or more machine-learning models. The machine-learning models can include any machine-learning model (e.g., deep neural networks, convolutional neural networks, recurrent neural networks, recursive neural networks, decision trees, logistic regression models, support vector machines, etc.) and/or any other models configured to generate the multi-modal transportation data 715 based on one or more inputs. In some implementations, the one or more machine-learning models can be learned (e.g., via one or more supervised training techniques) over a set a training data such as, for example, historical multi-modal transportation data (and/or single mode transportation data) gathered over one or more previous operational time periods. By way of example, the historical multi-modal transportation data can be indicative of a number of requests and/or one or more attributes of the number of requests at one or more historical time steps. The network model 805 can model the multi-modal transportation data 715 by determining one or more correlations between a number of requests, the one or more attributes of the number of requests, and/or the one or more historical time steps associated with the requests. For example, the network model 805 and/or one or more portions 810, 815, 820 thereof can be learned over the historical multi-modal transportation data. The multi-modal transportation data 715 can be provided to the simulation system 139 for use in generating simulation data.

The multi-modal transportation data 715 can include itinerary data indicative of a number of services expected to be requested during the operational time period and one or more expected transportation request attributes of each of the expected service requests. The one or more expected transportation request attributes, for example, can include a type of requested service (e.g., single passenger transportation, group passenger transportation, item transportation, etc.), a time sensitivity of the requested service, a capacity sensitivity of the requested service, one or more locations (e.g., origin, destination, etc.) associated with the requested service, etc. For example, the attribute(s) can identify an aerial transport facility (e.g., an origin facility, an intermediate facility, a destination facility, etc.) associated with each of the expected requests, a number of services expected to be fulfilled by each aerial transport facility, a number/type aerial vehicles needed to service each of the expected requests, a number/type of aerial vehicles at each aerial transport facility needed to service the expected requests, etc.

The candidate itinerary data 725 can be indicative of a plurality of candidate flight itineraries at a respective time step during the operational time period. For instance, the candidate itinerary data 725 can be indicative of a plurality of possible flight itineraries available between one or more aerial transportation facilities at the respective time step. The candidate itinerary data 725 can be generated by a candidate model 825 configured to determine the availability of a plurality of candidate itineraries between a plurality of aerial transport facilities at one or more time steps throughout the operational time period. In some implementations, the candidate model 825 can include one or more machine-learning models. The machine-learning models can include any machine-learning model (e.g., deep neural networks, convolutional neural networks, recurrent neural networks, recursive neural networks, decision trees, logistic regression models, support vector machines, etc.) and/or any other models configured to generate the candidate itinerary data 725 based on one or more inputs. In some implementations, the one or more machine-learning models can be learned (e.g., via one or more supervised training techniques) over a set a training data such as, for example, historical candidate itinerary data gathered over one or more previous operational time periods. By way of example, the historical candidate itinerary data can be indicative of an availability of one or more flight itineraries under one or more different scenarios (e.g., time of day, predicted demand, currently scheduled itineraries, etc.). The candidate model 825 can be learned over the historical candidate itinerary data to predict the candidate itinerary data 725 based on the circumstances of the operational time period.

For instance, the candidate model 825 can be configured to determine a respective plurality of candidate flight itineraries for one or more time steps throughout the operational time period. The respective candidate flight itineraries can include every possible flight itinerary that is available between each aerial transport facility of a fixed transportation infrastructure at a respective time step of the operational time period. The candidate itinerary data 725 can be determined based on the number and/or type of aerial vehicle(s) available at each facility at the respective time step, a number of skylanes (e.g., vehicle travel lanes/bounded areas, etc.) available at the respective time step, the number and/or availability of take-off/landing points of each aerial transport facility, etc.

The candidate itinerary data 725 can be determined by the scheduling system (e.g., service entity computing system 102, vehicle provider computing system 140) based on vehicle data. For instance, as described in further detail herein, the vehicle data can include location data, component data, and/or availability data for each aerial vehicle of a fleet of aerial vehicles. The location data can identify a current and/or predicted location (e.g., aerial transportation facility, etc.) of a respective aerial vehicle. The component data can identify current and/or predicted health data for one or more components of the aerial vehicle. And, the availability data can identify a current and/or predicted assignment (e.g., a service assignment, a servicing assignment, etc.) for the aerial vehicle.

More particularly, with reference to FIG. 4, the vehicle data (e.g., vehicle data 720 of FIG. 7) can be indicative of a component state 430 of one or more vehicle components 425 for each of a plurality of aerial vehicles of a fleet of aerial vehicles 405, 450, 455. For example, the vehicle data can include the vehicle model 410 for each respective aerial vehicle. For instance, each respective aerial vehicle of the plurality of aerial vehicles can include a corresponding vehicle model 410 uniquely tailored to the attributes of the aerial vehicle.

The vehicle data can be indicative one or more vehicle attributes associated with a plurality of aerial vehicles of the fixed transportation infrastructure. For example, the computing system(s) 102, 140 can utilize a plurality of aerial vehicles for facilitating aerial transportation services for a number of riders. Each of the vehicles can be stored, maintained, and/or otherwise associated with a respective aerial transport facility at one or more time steps of the operational time period. Each vehicle can be associated with vehicle data indicative of a state (e.g., location, power level, etc.) of the vehicle at one or more time steps of the operational time period. For example, the vehicle data for a respective vehicle can include one or more of battery health data (e.g., a current, predicted, etc. power level of the vehicle), a vehicle health data (e.g., a state of one or more components of the vehicle), pilot data (e.g., a current, predicted, etc. available time of an operator of the vehicle), usage data (e.g., flight hours, etc.), or location data (e.g., current, predicted, etc. location of the vehicle) associated with the respective vehicle.

As an example, each vehicle can be associated with a vehicle model 410 indicative of the one or more vehicle attributes of the respective vehicle at a current time step. The vehicle attributes can include one or more operational capabilities 420, a list of components 425 and/or types of components of the aerial vehicle, and/or a current state 430 of the vehicle and/or health of each of the vehicle components. The vehicle components 425, for example, can include one or more hardware components and/or software components for each of the plurality of aerial vehicles. The hardware components can include at least one of one or more power components (e.g., an engine, fuel tank, battery, etc.), climate control components, navigation components, flight control components, etc. The one or more software components can include one or more software applications (e.g., an operating system, a user interface, etc.) associated with the aerial vehicle. The component state 430 of each of the vehicle components 425 can identify a health (e.g., a power level, a current software version, etc.) of each of the one or more components 425. For example, the component state 430 of a power component can identify a power level (e.g., fuel level, charge level, etc.) of the power component (e.g., battery, fuel tank, etc.) for a respective aerial vehicle.

In addition, or alternatively, the vehicle model 410 can be indicative of usage information 445 (e.g., historical usage, current usage, expected usage, etc.) for a respective aerial vehicle. The usage data 445 can be indicative historical, current, and/or expected flight time for the vehicle and/or the operator of the vehicle, a historical, current, and/or expected location of the vehicle, etc. In some cases, the current state of an aerial vehicle and/or one or more component(s) 425 of the aerial vehicle can be determined based at least in part on the usage data 445.

In some implementations, the vehicle model 410 can be associated with one or more component models 435. For example, the vehicle model 410 can be associated with a battery model modelling one more attributes of a battery of the aerial vehicle. For instance, the battery model can be indicative of one or more performance characteristic(s) of an electric battery of a respective aerial vehicle. The performance characteristics can be indicative of an expected long term performance (e.g., life expectancy) of the battery and/or an expected short term performance (e.g., charge level) of the battery. In addition, the performance characteristics can be indicative of servicing (e.g., slow charge, fast charge, etc.) that can affect the expected long term and/or short term performance of the battery. The battery model can include structural information such as a type of cells used, the chemistry within each of the cells, an organizational structure of the cells, how cell modules are packed together, materials used that may affect the dissipation of heat, etc. In some implementations, the performance characteristics of the electric battery can be determined based, at least in part, on the structural information.

Turning back to FIG. 7, in some implementations, the scheduling system 705 can include the vehicle provider computing system 140 of FIG. 1. In such a case, the vehicle provider computing system 140 can obtain the vehicle data 720, determine the candidate itinerary data 725 based on the vehicle data 720, and provide the candidate itinerary data 725 to the simulation system 138. In addition, or alternatively, the scheduling system 705 can include the service entity computing system 102. In such a case, the service entity computing system 102 can obtain the vehicle data 720 (e.g., via a service entity fleet of vehicles, one or more vehicle providers, the vehicle provider computing system 140, etc.) determine the candidate itinerary data 725 based on the vehicle data 720, and provide the candidate itinerary data 725 to the simulation system 138.

The simulation data 710 can be generated (e.g., by the simulation system 138) based on the multi-modal transportation data 715, the candidate itinerary data 725, and/or the vehicle data 720. The simulation data 710 can be indicative of a plurality of simulated flight itineraries at one or more time steps throughout the operational time period. The plurality of simulated flight itineraries can be associated with one or more multi-modal transportation itineraries. For example, each simulated flight itinerary can include at least one transportation leg of a multi-modal transportation itinerary. A simulated flight itinerary can include a flight itinerary performed within a simulated world environment. The simulated world environment can represent the real world and use the real world as constraints on the generation of simulated flight itineraries and the performance of the simulated flight itineraries.

The simulation system 138 can generate the plurality of simulated flight itineraries based on one or more operational constraints 740. The operational constraint(s) 740 can represent real time and/or predicted demand, supply, weather, and/or any other factor that can affect transportation services throughout an operational time period. The operational constraint(s) 740 can be defined based, at least in part, on the data described herein. The simulation system 138 can simulate a plurality of simulated flight itineraries for each time step throughout the operational time period. For instance, at each respective time step, the simulation system 138 can generate a plurality of simulated flight itineraries based on real-time data up to a current time step and predicted data for one or more time steps subsequent to the current time step. The real-time and/or predicted data can be represented as the one or more operational constraint(s) 740.

As discussed herein, the simulation system 138 can include and/or have access to one or more models (e.g., network model, candidate models, optimization model, etc.) configured determine one or more of the operational constraint(s) 740. Each of the models can determine the one or more operational constraint(s) 740 based on real time data. The real time data can be indicative of at least one of a number of requests for aerial transport services, one or more scheduled flight itineraries 750, vehicle data 720, and/or environment data 735 at or up to a current time step. As an example, the network model can estimate updated demand data for each respective time step of the operational time period based on a real-time demand (e.g., as indicated by requests for aerial transportation services, one or more scheduled flight itineraries 750, etc.) for aerial transport services at or up to the respective time step for which it is available. As another example, the environmental data 735 can be estimated based on real-time weather data, traffic data, etc. indicative of the current weather and/or traffic conditions. For example, the environmental data 735 can be indicative of one or more environmental conditions (e.g., weather, traffic, etc.) at and/or up to the current time step.

The simulation system 138 can generate the plurality of simulated flight itineraries based on the operational constraint(s) 740 (e.g., demand data, etc.) and/or one or more candidate flight itineraries. The operational constraint(s) 740 can include one or more demand constraints, multi-modal itinerary constraints, vehicle constraints, and/or environmental constraints for one or more time steps throughout the operational time period. For example, the simulation system 138 can obtain, via the demand model, demand data (e.g., multi-modal transportation data 715) for a respective time step. The demand data can be indicative of an anticipated demand for aerial transport services at the respective time step. In addition, or alternatively, the simulation system 138 can obtain, via the candidate model, a plurality of candidate flight itineraries (e.g., candidate itinerary data 725) for the respective time step. The simulation system 138 can generate a plurality of simulated flight itineraries for the respective time step based, at least in part, on the demand data and the plurality of candidate flight itineraries. This process can be repeated for one or more time steps throughout the operational time period based on any combination of the data described herein.

By way of example, a simulated flight itinerary can include a simulation of the performance of a flight within the simulated world environment. For example, the simulation system 138 can simulate the use of an aerial transportation facility for servicing, boarding, charging, and/or any other pre-flight tasks for preparing an aerial vehicle to perform the simulated flight itinerary. As an example, the simulated system 138 can obtain pre-flight operational constraints indicative of multi-modal transportation data 715 (e.g., a demand) for a flight departing at a respective time step. The simulation system 138 can schedule the simulated flight itinerary and assign one or more simulated passengers to the simulated flight itinerary based on the multi-modal transportation data 715. In addition, the pre-flight operational constraints can include vehicle data 720 indicative of the current and/or expected state (e.g., charge level, capacity, etc.) of one or more vehicles at the respective time step. The simulation system 138 can assign an aerial vehicle to perform the simulated flight itinerary and/or one or more pre-flight tasks (e.g., servicing, charging, fueling, etc.).

The simulation system 138 can obtain additional pre-flight operational constraints such as, for example, current/predicted weather, current/predicted traffic, availability of infrastructure equipment (e.g., charging/servicing equipment), other scheduled itineraries, etc. to simulate the one or more pre-flight tasks. For example, the simulation system 138 can simulate one or more delayed passengers based on traffic at the respective time step, one or more delayed fueling/charging tasks due to an unavailability of fueling/charging equipment at the respective time step, a delayed take-off due to unavailable landing pads, etc. In like manner, the simulation system 138, using the pre-flight operational constraints, can simulate the effect of the simulated flight itinerary on one or more other scheduled and/or simulated itineraries. For example, the simulation system 138 can simulate one or more delayed fueling/charging tasks due to an unavailability of fueling/charging equipment at the respective time step caused by the simulated flight itinerary, a delayed take-off and/or landing of another flight due to unavailable landing pads caused by the simulated flight itinerary, etc.

The simulation system 138 can simulate the performance of a flight based on the simulated flight itinerary. For example, the simulation system 138 can obtain flight operational constraints such as, for example, weather, sky lane congestion, air traffic control, etc. Based on the flight operational constraints, the simulation system 138 can simulate the performance of the flight. For example, the simulation system 138 can simulate a flight delay, turbulence, etc. based on weather, a noise level based on the aerial vehicle and/or route, etc. In addition, the simulation system 138 can simulate the use of an aerial transportation facility for landing, servicing, de-boarding, charging, and/or any other post-flight tasks after the performance of the simulated flight itinerary. As an example, the simulated system 138 can obtain post-flight operational constraints indicative of multi-modal transportation data 715 (e.g., a demand) for a flights departing/landing at an estimated landing time step, vehicle data 720 indicative of the current and/or expected state (e.g., charge level, capacity, etc.) of the vehicle at the time step, current/predicted weather, current/predicted traffic, availability of infrastructure equipment (e.g., charging/servicing equipment), other scheduled itineraries, etc. to simulate the one or more post-flight tasks.

The scheduling system 705 can optimize the scheduling of a plurality of scheduled itineraries 750 in view of the operational time period. For example, in some implementations, the simulation system 138 can generate an optimal list of simulated itineraries for a respective time step (e.g., a current time step) of the operational time period based on the plurality of simulated flight itineraries. The optimal list of simulated itineraries can include a ranked list of simulated flight itineraries. The simulated flight itineraries can be ranked according to an estimated impact that scheduling the simulated flight itinerary will have on one or more anticipated flight itineraries during the operational time period.

For example, the simulation system 138 can determine contextual data 760 for each of a plurality of simulated flight itineraries generated for the respective time step. The contextual data 760 can be indicative of a relative impact of a respective simulated flight itinerary on one or more metrics associated with the operational time period. The one or more metrics, for example, can include an overall noise level (e.g., noise caused by aircraft during the provision of an aerial transportation service), an overall profit margin (e.g., profit earned by the provision of the aerial transportation service(s)), an overall ride quality (e.g., an expectation of delays, etc.), an overall safety level, and/or any other measurement observed throughout an operational time period. As one example, the relative impact of the respective simulated flight itinerary can be determined based, at least in part, on a plurality of subsequent simulated flight itineraries generated for one or more time steps subsequent to the respective time step. The plurality of subsequent simulated flight itineraries can be generated based, at least in part, on the respective simulated flight itinerary and one or more operational constraint(s) 740 (e.g., an anticipated demand, a plurality of candidate flight itineraries, etc.) for the one or more time steps subsequent to the respective time step.

The simulation system 138 can generate an optimal list of itineraries including a ranked list of a subset of the plurality of simulated flight itineraries based, at least in part, on the contextual data 760 for each of the plurality of simulated flight itineraries. Each simulated flight itinerary of the optimized list of flight itineraries can be ranked based, at least in part, on a relative impact of the simulated flight itinerary to one or more of the metrics of the operational time period. As an example, the simulated flight itineraries can be ranked according to a cost function configured to minimize a predicted overall noise level, maximize a predicted profit margin, maximize a predicted overall ride quality, maximize vehicle safety and/or avoid probabilistic vehicle (and/or component) failures for the plurality of flight itineraries 750 scheduled during the operational time period. As an example, the cost function can evaluate a plurality of subsequent itineraries generated based on a simulated itinerary at a respective time step. The plurality of subsequent itineraries can include one or more sets of itineraries that are possible and/or likely after the simulated itinerary is scheduled. The cost function can analyze each combination of sets of itineraries to determine an estimated noise level, profit margin, ride quality, vehicle safety (e.g., probability of vehicle and/or component failures, etc.), etc. for each possible and/or likely combination of itineraries after the simulated itinerary is scheduled. The contextual data 760 for the simulated itinerary can include an indication of the estimated noise level, profit margin, ride quality, vehicle safety, and/or potential for vehicle (and/or component) failures for the operational time period in the event that the simulated itinerary is scheduled.

The cost function can be determined based on historical data indicative of a plurality of historical scheduled itineraries and metrics for each of the plurality of historical scheduled itineraries. In some implementations, the contextual data 760 can be determined by one or more machine-learning costing models. The one or one or more machine-learning costing models can include any machine-learning model (e.g., deep neural networks, convolutional neural networks, recurrent neural networks, recursive neural networks, decision trees, logistic regression models, support vector machines, etc.) and/or any other models configured to determine the contextual data 760 based on one or more inputs. In some implementations, the one or more machine-learning models can be learned (e.g., via one or more supervised training techniques) over a set a training data such as, for example, the plurality of historical scheduled itineraries and/or metrics thereof.

The scheduling system 705 can generate a multi-modal transportation itinerary by selecting a flight itinerary from the optimal list of simulated flight itineraries to facilitate an aerial transportation leg of the multi-modal transportation itinerary for a rider. For example, the scheduling system 705 can obtain the optimized list of flight itineraries for a respective time step associated with a request for the aerial transport. In some implementations, the optimized list of flight itineraries can be provided for display, via one or more display devices, to one or more users of the scheduling system 705 (e.g., one or more aerial transportation operators, schedulers, etc.). In such a case, each flight itinerary of the optimized list of flight itineraries can be displayed with contextual data 760 associated with the respective flight itineraries.

The scheduling system 705 (and/or user thereof) can select a flight itinerary from the optimized list of flight itineraries for a transportation leg of the multi-modal transportation itinerary associated with the aerial transport of the rider from the optimized list of flight itineraries. For example, the scheduling system 705 can obtain simulation data 710, vehicle data 720, one or more candidate itineraries (e.g., candidate itinerary data 725), and/or multi-modal transportation data 715 associated with the respective time step and select the flight itinerary based on this data. The selection of the selected flight itinerary can be performed by the scheduling system 705, via a selection algorithm of the scheduling system 705, and/or by a user of the scheduling system 705, via user input. For example, the selection algorithm can include an automatic selection logic that selects a simulated flight itinerary based on one or more attributes (e.g., highest ranked itinerary, lowest ranked itinerary, etc.) of the contextual data 760 accompanying the optimal list of flight itineraries. In addition, or alternatively, the scheduling system 705 can receive user input indicative of a selection of the selected flight itinerary. The user input can be received via one or more input devices (e.g., microphone, tactile device (e.g., keyboard, mouse, button, etc.), etc.) of the scheduling system 705 and/or via one or more devices communicatively connected to the scheduling system 705.

The scheduling system 705 can initiate the performance of the selected itinerary. For example, the scheduling system 705 can generate a multi-modal transportation itinerary based on the selected flight itinerary. The selected flight itinerary, for example, can include at least one transportation leg of the multi-modal transportation itinerary. The scheduling system 705 can assign one or more vehicles to provide one or more legs of the multi-modal transportation itinerary and/or otherwise facilitate the provision of a multi-modal transportation service for a rider of the multi-modal transportation itinerary.

The scheduling system 705 can provide data indicative of the multi-modal transportation itinerary as an input for updating the plurality simulated flight itineraries. For example, the operational constraint(s) 740 can be updated at each time step (e.g., each minute, five minutes, fifteen minutes, hour, etc.) throughout the operational time period based, at least in part, on real time data. By way of example, once selected, the one or more multi-modal itinerary constraints indicative of one or more scheduled multi-modal transportation itineraries can be updated based, at least in part, on the selected flight itinerary and/or multi-modal transportation itinerary thereof.

As an example, the selected flight itinerary and/or multi-modal transportation itinerary thereof can affect the one or more simulated flight itineraries by changing an availability of a take-off/landing pad and/or other infrastructure equipment at an aerial transportation facility, changing the demand data associated with a respective time step (e.g., by facilitating a portion of the demand, etc.), changing the vehicle data associated with the vehicle assigned to provide the selected itinerary (e.g., usage data can be indicative of the scheduled flight itinerary, battery/fuel can be expected to be lower after the performance of the flight itinerary, etc.), and/or changing any other operational constraint affected by a scheduled flight itinerary. The simulation system 138 can regenerate each of the plurality of simulated flight itineraries of the simulation data 710 based on the updated multi-modal itinerary constraints. In this manner, the plurality simulated flight itineraries of the simulation data 710 can be updated at each respective time step throughout the operational time period based, at least in part, on the one or more updated operational constraints at the respective time step.

As another example, the simulation system 138 can obtain real time data associated with a respective time step. The real time data can be indicative of a scheduled flight itinerary of the plurality of simulated flight itineraries. The simulation system 138 can update one or more parameters of the network model, demand model, candidate model, etc. based, at least in part, on the real time data. For example, the simulation system 138 can obtain, via the demand model, updated demand data for the respective time step. The updated demand data can identify the real-time demand for aerial transport services at the first time step. In addition, or alternatively, the simulation system 138 can obtain, via the candidate model, an updated plurality of candidate flight itineraries for the first time step. The simulation system 138 can modify the plurality of simulated flight itineraries for the respective time step based, at least in part, on the updated demand data and/or the updated plurality of candidate flight itineraries. As an example, the simulation data 710 can be modified to include less simulated flight itineraries based on a lower than expected demand, modified to include more simulated flight itineraries based on higher than expected demand, modified to delay one or more simulated flight itineraries based on real-time traffic data, modified to change one or more simulated flight itineraries to account for the scheduled flight itinerary (e.g., by reducing the number of requested flights based on the number of requests facilitated by the scheduled flight itinerary, reducing availability of one or more infrastructure/vehicles utilized to provide the scheduled flight itinerary, etc.).

In addition, or alternatively, the simulation system 138 can obtain real time data indicative of a deviation from at least one of the plurality of simulated flight itineraries. The deviation from the at least one of the plurality of simulated flight itineraries can include an unanticipated occurrence for a scheduled flight itinerary corresponding to the simulated flight itinerary that causes the scheduled flight itinerary to deviate from the simulated flight itinerary. The deviation can be indicative of at least one of an environmental condition, a flight delay, traffic delay, etc. By way of example, the unanticipated occurrence can include greater traffic congestion than anticipated, a late/early passenger, a larger/lower than expected capacity, one or more weather anomalies etc. and/or the one or more deviations can include a delayed/early flight itinerary, an earlier/later departure time, an earlier/later landing time, a lower/higher anticipated power expenditure for a vehicle providing the aerial transportation service for the flight itinerary, etc.

In response to obtaining the real time data indicative of the deviation, the simulation system 138 can generate a plurality of regenerated simulated flight itineraries based, at least in part, on the plurality of simulated flight itineraries and the real time data. As one example, greater traffic congestion than anticipated can delay a scheduled flight itinerary. In response, one or more simulated flight itineraries generated based on the original time of departure of the scheduled flight itinerary can be delayed as well in order to avoid congestion of one or more take-off/landing pads of an aerial transportation facility.

The scheduling system 705 can update a multi-modal transportation itinerary (and/or flight itinerary thereof) associated with the deviation based, at least in part, on the plurality of regenerated simulated flight itineraries. For example, the scheduling system 705 can assign a different vehicle for providing the aerial transportation service of the multi-modal transportation itinerary, replace the aerial transportation leg of the multi-modal transportation itinerary with a different flight itinerary, etc.

In some implementations, the simulation data 710 can be generated and/or modified based, at least in part, on servicing data 730. The servicing data 730 can include a servicing schedule for one or more anticipated servicing events during the operational time period. An anticipated servicing event can identify a potential opportunity for servicing an aerial vehicle during the operational time period. For example, an anticipated servicing event can include a servicing event, as discussed with reference to FIG. 5. An anticipated servicing event can be identified based on a health of one or more components of an aerial vehicle. The anticipated servicing events can be identified and scheduled during an operational time period to maintain the operational capabilities of an aerial vehicle.

The servicing schedule can be indicative of an availability of one or more aerial vehicles throughout the operational time period. The simulation system 138 can obtain the servicing schedule and update one or more simulated itineraries of the simulation data 710 based on the availability of the one or more aerial vehicles. For example, the servicing system 139 can provide the servicing schedule as an input for updating the plurality simulated flight itineraries. For instance, the one or more operational constraints 740 (e.g., vehicle constraints, etc.) can be indicative of an availability of one or more of the plurality of aerial vehicles. The one or more operational constraints 740 (e.g., vehicle constraints, etc.) can be updated based, at least in part, on the servicing schedule. The operational constraint(s) 740 can be updated at each time step throughout the operational time period based, at least in part, on real time data indicative of the performance of at least one of the one or more anticipated servicing events.

The servicing system 139 can generate servicing data 730 (e.g., servicing schedule) for one or more time steps throughout the operational time period. The servicing data 730 can be generated based on real-time data (e.g., up to a respective time step), simulation data 710, vehicle data 720, and/or any other data described herein. For instance, the servicing system 139 can obtain vehicle data 720 associated with a plurality of aerial vehicles. As discussed herein, the vehicle data 720 can be indicative of a component state of one or more components for each of the plurality of aerial vehicles. In addition, the servicing system 139 can obtain simulation data 710 indicative of the plurality of simulated flight itineraries at one or more time steps throughout the operational time period. The servicing system 139 can generate the servicing schedule for one or more anticipated servicing events during the operational time period based, at least in part, on the vehicle data 720 and the simulation data 710 and output the servicing schedule (e.g., to the scheduling system 705, the simulation system 138, etc.). As described herein, the servicing schedule can include a number of vehicle servicing events scheduled during opportunistic time windows identified based on real-time data, simulation data 710, vehicle data 720, etc.

More particularly, the servicing system 139 can determine an anticipated schedule for at least one aerial vehicle of the plurality of aerial vehicles based, at least in part, on the simulation data 710. The servicing system 139 can identify the anticipated servicing event for the at least one aerial vehicle based, at least in part, on the anticipated schedule and vehicle data 720 associated with the aerial vehicle. By way of example, the anticipated servicing event can be identified based on usage data indicative of the expected utilization of the at least one aerial vehicle. For instance, the usage data can identify an expected power level decrease, an expected hardware degradation, etc. due to the performance of one or more aerial vehicle services. As an example, a power level can be predicted (via one or more simulated itineraries, etc.) for completing an anticipated schedule of aerial vehicle services for a respective aerial vehicle. By way of example, each simulated itinerary can include a simulation of the respective aerial vehicle's performance of a flight itinerary from one aerial transportation facility to another aerial transportation facility through environmental conditions (e.g., rain, wind, etc.) predicted for the flight. A power level expenditure can be predicted for each flight based on the predicted use of power for performing the flight itinerary under the simulated conditions by the aerial vehicle. The predicted power level can be compared to the current power level (e.g., as indicated by the vehicle data 720) of an aerial vehicle and a servicing event can be anticipated for recharging/fueling the vehicle at a time step where the vehicle is not expected to be in use and requires a recharge/refuel.

In some implementations, the servicing system 139 can determine a servicing time period during the operational time period for the performance of the anticipated servicing event based, at least in part, on the anticipated servicing event, the vehicle data 720 associated with the aerial vehicle, and the simulation data 710. The servicing time period can be determined opportunistically to minimize the impact of the anticipated servicing event on the plurality of simulated flight itineraries. Moreover, the servicing time period can be determined to minimize the impact of the anticipated servicing event on the health of a respective aerial vehicle. For instance, the servicing time period can be determined such that an aerial vehicle uses a threshold amount of available power before being recharged/refueled (e.g., to increase charging speed, power component health, etc.). In addition, or alternatively, the servicing system 139 can obtain data associated with one or more servicing locations and/or one or more servicing personnel. For instance, the data can be indicative of an availability of the one or more servicing locations (and/or servicing equipment thereof) and/or the one or more servicing personnel. The servicing system 139 can determine the servicing time period and/or a servicing location for the anticipated servicing event based, at least in part, on the data, one or more servicing attributes associated with the servicing event, and/or the simulation data 710.

In some implementations, the servicing computing system 139 can obtain a vehicle request for one or more of a plurality of aerial vehicles for the performance of one or more anticipated, scheduled, simulated, etc. aerial transportation services during the operational time period. By way of example, the simulation system 138 and/or the scheduling system 705 can request one or more vehicles for the performance of one or more simulated and/or scheduled flight itineraries based on an anticipated demand that exceeds a number of available vehicles. For example, the simulation data 710 can be indicative of a first set of a plurality of aerial vehicles for providing one or more simulated flight itineraries at a respective time step of the operational time period. The first set of the plurality of aerial vehicles can include a number of aerial vehicles available for performing a transportation service at the respective time step. The vehicle request can be indicative of a second set of the plurality of aerial vehicles for providing one or more simulated flight itineraries at the respective time step of the operational time period. The second set of the plurality of aerial vehicles can include a number of aerial vehicle that are requested to be available at the respective time step. The second set can be different from the first set. For example, the second set can include a greater number of aerial vehicles (e.g., due to a higher than anticipated demand at a respective time step, etc.) than the first set of the plurality of aerial vehicles. As another example, the second set of the plurality of aerial vehicles can be less (e.g., due to a lower than anticipated demand at a respective time step, etc.) than the first set of the plurality of aerial vehicles.

The servicing system 139 can determine one or more servicing options based, at least in part, on the vehicle data 720, the servicing schedule (e.g., servicing data 730), and/or the vehicle request. The one or more servicing options can be indicative of one or more modifications to the servicing schedule and/or one or more transportation services. In some implementations, each respective servicing option of the one or more servicing options can include contextual data indicative of the impact of the respective servicing option on one or more of the plurality of aerial vehicles (e.g., the availability of the aerial vehicle, the vehicle state of the aerial vehicle, etc.). For example, in the event that the vehicle request includes a second set of vehicles greater than the first set of vehicles, each of the one or more servicing options can be indicative of one or more additional aerial vehicles, a component state of one or more components of each of the one or more additional aerial vehicles, and contextual data indicative of one or more mitigating performance factors associated with the plurality of aerial vehicles. The one or more mitigating performance factors can include one or more consequences of creating the availability of additional vehicles at a respective time step. The consequence(s) can include, for example, a lower lifespan of one or more components of the vehicle, a consequential unavailability at another time step, an unavailability of another vehicle, etc.

By way of example, the one or more servicing options for creating additional availability can include taking a component from one uncharged vehicle to repair another charged vehicle to make the charged vehicle available at a respective time step. In such a case, the one or more servicing options can identify the charged and uncharged vehicle, a current component state of the replaceable component for each aerial vehicle, and/or the mitigating performance factor of reducing the availability of the uncharged vehicle. As another example, the one or more servicing options can include fast charging a power component for an aerial vehicle to make the vehicle available at the respective time step at the cost of the overall life span of the power component. In such a case, the one or more servicing options can identify a vehicle capable of fast charging, a current component state of the power component of the aerial vehicle, and the mitigating performance factor of a lower life span of the power component of the aerial vehicle.

In the event that the request includes a second set of vehicles less than the first set of vehicles, each of the one or more servicing options can be indicative of one or more aerial vehicles of the first set of the plurality of aerial vehicles, a component state of one or more components of each of the one or more aerial vehicles, and contextual data indicative of one or more positive performance factors associated with the one or more aerial vehicles. By way of example, the one or more servicing options can include slow charging a power component for an aerial vehicle to reduce the vehicle availability at a respective time step because it is no longer needed for the respective time step. In such a case, the one or more servicing options can identify a vehicle capable of slow charging, a current component state of the power component of the aerial vehicle, and/or the positive performance factor of increasing the life span of the power component of the aerial vehicle.

The servicing system 139 can provide the one or more servicing options to the scheduling system 705 and/or simulation system 138. For example, the one or more servicing options can be provided for display, via one or more display devices, to one or more users of the system(s) 705, 138 (e.g., one or more aerial transportation operators, etc.). In such a case, each servicing option can be displayed with contextual data associated with the servicing option. The system(s) 705, 138 (and/or user thereof) can select a servicing option from the one or more servicing options. The selection of the selected servicing option can be performed by the system(s) 705, 138, via a selection algorithm of the system(s) 705, 138, and/or by a user of the system(s) 705, 138, via user input. For example, the selection algorithm can include an automatic selection logic that selects a servicing option based on the contextual data accompanying the one or more servicing options. In addition, or alternatively, the system(s) 705, 138 can receive user input indicative of a selection of the servicing option. The user input can be received via the one or more input devices (e.g., microphone, tactile device (e.g., keyboard, mouse, button, etc.), etc.) of the system(s) 705, 138.

The servicing system 139 can obtain (e.g., from the simulation system 138, the scheduling system 705, and/or one or more users thereof) data indicative of a selection of at least one servicing option of the one or more servicing options. In response, the servicing system 139 can modify the servicing schedule and/or the one or more transportation services based, at least in part, on the at least one servicing option.

By way of example, the servicing system 139 can obtain data indicative of a selection of at least one servicing option of the one or more servicing options indicative of a change to at least one transportation service. The change to the transportation service can include a modification of a departure time for the transportation service, a modification of a destination location, a modification of flight capacity, and/or any other modification to the at least one transportation service. In response, the servicing system 139 can modify the transportation service based, at least in part, on the at least one servicing option. As one example, the servicing system 139 can modify a departure time for the transportation service to accommodate a charging service for a respective aerial vehicle assigned to perform the at least one transportation service. For instance, the servicing system 139 can identify (e.g., through the at least one servicing option) a charging advantage associated with the charging service for the respective aerial vehicle. The charging advantage, for instance, can be associated with an increase and/or decrease to the long-term health and/or a short-term health of an electric battery (e.g., as indicated by a respective vehicle model) of the respective aerial vehicle. In such a case, the servicing system 139 can modify the departure time for the at least one transportation service to accommodate the charging service for the respective aerial vehicle based at least in part on the charging advantage.

By way of example, the servicing system 139 can balance providing the minimum possible journey time for a rider that may already have boarded (by leaving immediately) with potential savings/advantages that may be realized by providing the aerial vehicle with additional charge time. The simulation system 138 can be used to determine the downstream/future effects of charging the aerial vehicle for a greater time period by using the additional charge time as a simulation parameter, varying the charge time to find an optimal charge time, etc. This can include determining, using the simulation techniques described herein, whether additional charging time would allow the aerial vehicle to transport riders a longer distance and/or provide additional aerial transportation service at a later time (e.g., due to less future charge time at a subsequent aerial transport facility). Moreover, the simulation system 138 can determine whether additional charge time would help reduce wear and tear on the batteries of the aerial vehicle and/or reduce the need for other types of maintenance for the aerial vehicle (e.g., so that it remains available for more vehicle services). Moreover, the simulation system 138 can determine whether additional charge time would result in a higher revenue earned by the aerial vehicle (e.g., by transporting riders).

Additionally, or alternatively, the simulation system 138 can determine whether charging time should be adjusted based at least in part on the future availability of charging infrastructure for the aerial vehicle. By way of example, the aerial vehicle can be allocated additional charging time at a particular aerial transport facility (e.g., a first aerial transport facility) if a subsequent aerial facility (e.g., a second aerial transport facility) to which the aerial vehicle is to travel (or is simulated to travel), does not include charging/fueling infrastructure for the aerial vehicle. This can include, for example, aerial facilities without charging/fueling infrastructure and/or facilities with infrastructure that is incompatible (e.g., associated with a different aerial vehicle type), less efficient (e.g., no high speed charging for a type of aerial vehicle), etc. for the aerial vehicle.

In some implementations, the aerial vehicle can charge its batteries for an additional time, if waiting would increase the probability (e.g., over 80%) that an additional rider would be matched to the aerial vehicle for aerial transportation at the facility where the aerial vehicle would receive the additional charging. In some implementations, if the advantages of additional charging outweigh the potential costs, a rider already assigned to the aerial vehicle could be provided with a discount or other type of incentive to balance any additional time that the rider may have to wait.

Instructions and schedules (e.g., servicing schedules, etc.) for the aerial vehicle can be developed based at least in part on the charging times determined. For example, a flight schedule, flight itinerary, servicing schedule, multi-modal transportation itinerary, etc. can be generated and/or adjusted to include additional charging time in the event that the results of one or more simulations indicate that such charging would be advantageous.

The servicing system 139 can initiate the one or more modifications to the servicing schedule and/or transportation services by providing information indicative of the one or more modifications to one or more computing devices (e.g., facility devices, servicing devices, vehicle devices, vehicle provider devices, service provider devices, etc.) associated with the multi-modal transportation itinerary. The information indicative of the one or more modifications can include providing notifications of a modified transportation service (e.g., to the scheduling system 705), toggling the availability of one or more aerial vehicles associated with the modification(s), providing a notification indicative of a servicing event to a facility, servicing personnel, and/or any other device associated with the provision of the servicing event, and/or providing another notification indicative of the servicing event to the vehicle, vehicle provider, and/or any other device associated with the vehicle.

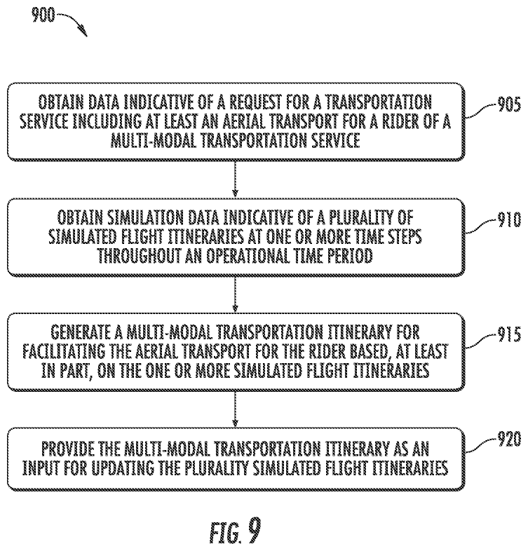

Turning to FIG. 9, FIG. 9 depicts a flowchart of an example method 900 for generating simulation data according to example embodiments of the present disclosure. One or more portion(s) of the method 900 can be implemented by a computing system that includes one or more computing devices such as, for example, the computing systems described with reference to the other figures (e.g., system 100, service entity computing system 102, simulation system 138, servicing system 139, vehicle provider computing system(s) 140, etc.). Each respective portion of the method 900 can be performed by any (or any combination) of one or more computing devices. Moreover, one or more portion(s) of the method 900 can be implemented as an algorithm on the hardware components of the device(s) described herein (e.g., as in FIGS. 1, 4, 7, 11, etc.), for example, to generate a multi-modal transportation itinerary based on simulation data. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 9 is described with reference to elements/terms described with respect to other systems and figures for exemplary illustrated purposes and is not meant to be limiting. One or more portions of method 900 can be performed additionally, or alternatively, by other systems.

At 905, the method 900 can include obtaining data indicative of a request for a transportation service including at least an aerial transport for a rider of a multi-modal transportation service. For example, a computing system (e.g., service entity computing system 102, optimization/planning system 130, simulation system 138, etc.) can obtain the data indicative of the request for the transportation service including at least the aerial transport for the rider of the multi-modal transportation service.

At 910, the method 900 can include obtaining simulation data indicative of a plurality of simulated flight itineraries at one or more time steps throughout an operational time period. For example, the computing system (e.g., service entity computing system 102, optimization/planning system 130, simulation system 138, etc.) can obtain the simulation data indicative of the plurality of simulated flight itineraries at one or more time steps throughout the operational time period.

At 915, the method 900 can include generating a multi-modal transportation itinerary for facilitating the aerial transport for the rider based, at least in part, on the one or more simulated flight itineraries. For example, the computing system (e.g., service entity computing system 102, optimization/planning system 130, simulation system 138, etc.) can generate the multi-modal transportation itinerary for facilitating the aerial transport for the rider based, at least in part, on the one or more simulated flight itineraries.

At 920, the method 900 can include providing the multi-modal transportation itinerary as an input for updating the plurality simulated flight itineraries. For example, the computing system (e.g., service entity computing system 102, optimization/planning system 130, simulation system 138, etc.) can provide the multi-modal transportation itinerary as an input for updating the plurality simulated flight itineraries.

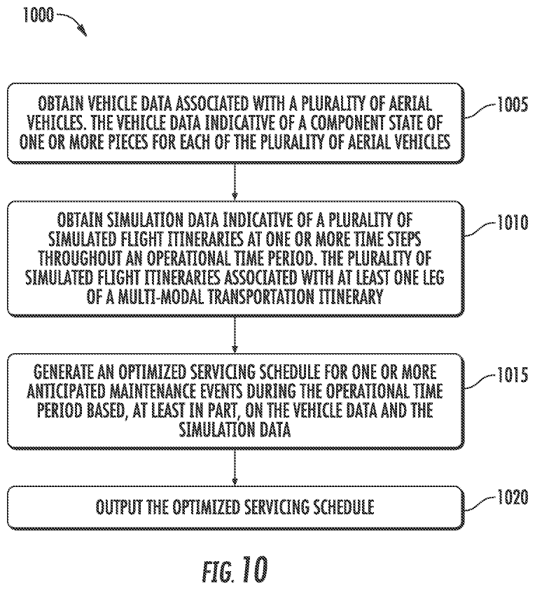

Turning to FIG. 10, FIG. 10 depicts a flowchart of an example method 1000 for generating servicing data according to example embodiments of the present disclosure. One or more portion(s) of the method 1000 can be implemented by a computing system that includes one or more computing devices such as, for example, the computing systems described with reference to the other figures (e.g., system 100, service entity computing system 102, simulation system 138, servicing system 139, vehicle provider computing system(s) 140, etc.). Each respective portion of the method 1000 can be performed by any (or any combination) of one or more computing devices. Moreover, one or more portion(s) of the method 1000 can be implemented as an algorithm on the hardware components of the device(s) described herein (e.g., as in FIGS. 1, 4, 7, 11, etc.), for example, to generate an optimal servicing schedule based on simulation data. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1005, the method 1000 can include obtaining vehicle data associated with a plurality of aerial vehicles. For example, a computing system (e.g., service entity computing system 102, servicing system 139, vehicle provider computing system 140, etc.) can obtain the vehicle data associated with the plurality of aerial vehicles. The vehicle data can be indicative of a component state of one or more components for each of the plurality of aerial vehicles.

At 1010, the method 1000 can include obtaining simulation data indicative of a plurality of simulated flight itineraries at one or more time steps throughout an operational time period. For example, the computing system (e.g., service entity computing system 102, servicing system 139, vehicle provider computing system 140, etc.) can obtain the simulation data indicative of the plurality of simulated flight itineraries at one or more time steps throughout an operational time period. The plurality of simulated flight itineraries can be associated with at least one leg of a multi-modal transportation itinerary.

At 1015, the method 1000 can include generating a servicing schedule for one or more anticipated servicing events during the operational time period based, at least in part, on the vehicle data and the simulation data. For example, the computing system (e.g., service entity computing system 102, servicing system 139, vehicle provider computing system 140, etc.) can generate the servicing schedule for the one or more anticipated servicing events during the operational time period based, at least in part, on the vehicle data and the simulation data.

At 1020, the method 1000 can include outputting the servicing schedule. For example, the computing system (e.g., service entity computing system 102, servicing system 139, vehicle provider computing system 140, etc.) can output the servicing schedule.

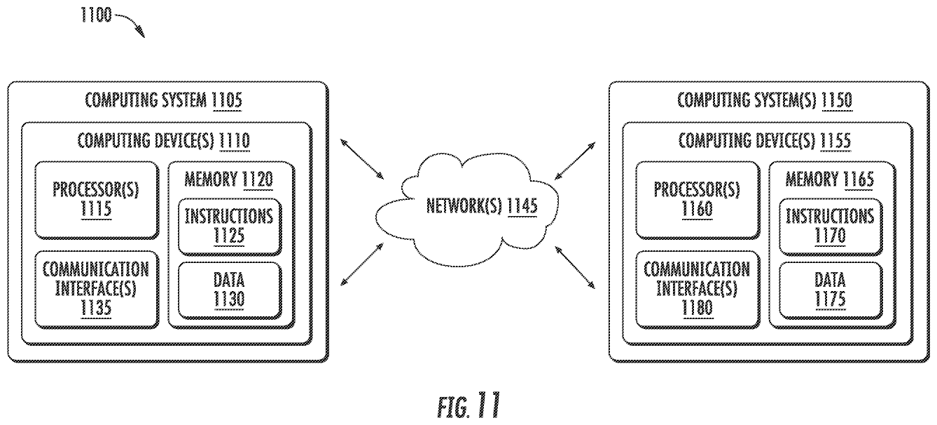

FIG. 11 depicts example system components of an example system 1100 according to example embodiments of the present disclosure. The example system 1100 can include the computing system 1105 (e.g., service entity computing system 102) and the computing system(s) 1150 (e.g., vehicle provider computing system(s) 140, rider computing device(s) 145, service provider computing device(s) 150, 160, 170, infrastructure and operations computing device(s) 190, etc.), etc. that are communicatively coupled over one or more network(s) 1145.

The computing system 1105 can include one or more computing device(s) 1110. The computing device(s) 1110 of the computing system 1105 can include processor(s) 1115 and a memory 1120. The one or more processors 1115 can be any suitable processing device (e.g., a processor core, a microprocessor, an ASIC, a FPGA, a controller, a microcontroller, etc.) and can be one processor or a plurality of processors that are operatively connected. The memory 1120 can include one or more non-transitory computer-readable storage media, such as RAM, ROM, EEPROM, EPROM, one or more memory devices, flash memory devices, etc., and combinations thereof.

The memory 1120 can store information that can be accessed by the one or more processors 1115. For instance, the memory 1120 (e.g., one or more non-transitory computer-readable storage mediums, memory devices) can include computer-readable instructions 1125 that can be executed by the one or more processors 1115. The instructions 1125 can be software written in any suitable programming language or can be implemented in hardware. Additionally, or alternatively, the instructions 1125 can be executed in logically and/or virtually separate threads on processor(s) 1115.

For example, the memory 1120 can store instructions 1125 that when executed by the one or more processors 1115 cause the one or more processors 1115 to perform operations such as any of the operations and functions for which the computing system is configured, as described herein.

The memory 1120 can store data 1130 that can be obtained, received, accessed, written, manipulated, created, and/or stored. The data 1130 can include, for instance, simulation data, servicing data, multi-modal transportation services data, and/or other data/information described herein. In some implementations, the computing device(s) 1110 can obtain from and/or store data in one or more memory device(s) that are remote from the computing system 1105 such as one or more memory devices of the computing system 1150.

The computing device(s) 1110 can also include a communication interface 1135 used to communicate with one or more other system(s) (e.g., computing system 1150). The communication interface 1135 can include any circuits, components, software, etc. for communicating via one or more networks (e.g., 1145). In some implementations, the communication interface 1135 can include for example, one or more of a communications controller, receiver, transceiver, transmitter, port, conductors, software and/or hardware for communicating data/information.

The computing system 1150 can include one or more computing devices 1155. The one or more computing devices 1155 can include one or more processors 1160 and a memory 1165. The one or more processors 1160 can be any suitable processing device (e.g., a processor core, a microprocessor, an ASIC, a FPGA, a controller, a microcontroller, etc.) and can be one processor or a plurality of processors that are operatively connected. The memory 1165 can include one or more non-transitory computer-readable storage media, such as RAM, ROM, EEPROM, EPROM, one or more memory devices, flash memory devices, etc., and combinations thereof.

The memory 1165 can store information that can be accessed by the one or more processors 1160. For instance, the memory 1165 (e.g., one or more non-transitory computer-readable storage mediums, memory devices) can store data 1175 that can be obtained, received, accessed, written, manipulated, created, and/or stored. The data 1175 can include, for instance, vehicle data, simulation data, itinerary data, and/or other data or information described herein. In some implementations, the computing system 1150 can obtain data from one or more memory device(s) that are remote from the computing system 1150.

The memory 1165 can also store computer-readable instructions 1170 that can be executed by the one or more processors 1160. The instructions 1170 can be software written in any suitable programming language or can be implemented in hardware. Additionally, or alternatively, the instructions 1170 can be executed in logically and/or virtually separate threads on processor(s) 1160. For example, the memory 1165 can store instructions 1170 that when executed by the one or more processors 1160 cause the one or more processors 1160 to perform any of the operations and/or functions described herein, including, for example, any of the operations and functions of the devices described herein, and/or other operations and functions.

The computing device(s) 1155 can also include a communication interface 1180 used to communicate with one or more other system(s). The communication interface 1180 can include any circuits, components, software, etc. for communicating via one or more networks (e.g., 1145). In some implementations, the communication interface 1180 can include for example, one or more of a communications controller, receiver, transceiver, transmitter, port, conductors, software and/or hardware for communicating data/information.

The network(s) 1145 can be any type of network or combination of networks that allows for communication between devices. In some embodiments, the network(s) 1145 can include one or more of a local area network, wide area network, the Internet, secure network, cellular network, mesh network, peer-to-peer communication link and/or some combination thereof and can include any number of wired or wireless links. Communication over the network(s) 1145 can be accomplished, for instance, via a network interface using any type of protocol, protection scheme, encoding, format, packaging, etc.

FIG. 11 illustrates one example system 1100 that can be used to implement the present disclosure. Other computing systems can be used as well. Computing tasks discussed herein as being performed at a transportation services system, the simulation computing system, etc. can instead be performed remote from the respective system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, the method comprising:
obtaining, by a computing system comprising one or more computing devices, vehicle data associated with a plurality of aerial vehicles, wherein the vehicle data is indicative of a component state of one or more components for each of the plurality of aerial vehicles;
generating, by the computing system, a servicing schedule based, at least in part, on the vehicle data and simulation data indicative of a plurality of simulated flight itineraries at one or more time steps throughout an operational time period, wherein the servicing schedule is indicative of the performance of one or more anticipated servicing events during the operational time period;
obtaining, by the computing system, a request for one or more of the plurality of aerial vehicles for the performance of one or more aerial transportation services during the operational time period;
determining, by the computing system, one or more servicing options based, at least in part, on the vehicle data, the servicing schedule, and the request, wherein the one or more servicing options are indicative of one or more modifications to the servicing schedule or the one or more aerial transportation services; and
outputting, by the computing system, the one or more servicing options.

2. The computer-implemented method of claim 1, further comprising:
obtaining, by the computing system, data indicative of a selection of at least one servicing option of the one or more servicing options; and
modifying, by the computing system, the one or more transportation services based, at least in part, on the at least one servicing option.

3. The computer-implemented method of claim 2, wherein modifying the one or more transportation services based, at least in part, on the at least one servicing option comprises:
modifying, by the computing system, a departure time for at least one of the one or more transportation services to accommodate a charging service for a respective aerial vehicle assigned to perform the at least one transportation service.

4. The computer-implemented method of claim 3, wherein the vehicle data comprises a respective vehicle model for the respective aerial vehicle assigned to perform the at least one transportation service, wherein the respective vehicle model comprises a battery model indicative of performance characteristics of an electric battery of the respective aerial vehicle, and wherein modifying the departure time for the at least one transportation service to accommodate the charging service for the respective aerial vehicle assigned to perform the at least one transportation service comprises:
identifying, by the computing system, a charging advantage associated with the charging service for the respective aerial vehicle, the charging advantage associated with a long-term health or a short-term health of the electric battery of the respective aerial vehicle; and
modifying, by the computing system, the departure time for the at least one transportation service to accommodate the charging service for a respective aerial vehicle based at least in part on the charging advantage.

5. The computer-implemented method of claim 1, further comprising:
obtaining, by the computing system, data indicative of a selection of at least one servicing option of the one or more servicing options; and
modifying, by the computing system, the servicing schedule based, at least in part, on the at least one servicing option.

6. The computer-implemented method of claim 5, wherein each respective servicing option of the one or more servicing options comprises contextual data indicative of the impact of the respective servicing option on one or more of the plurality of aerial vehicles.

7. The computer-implemented method of claim 6, wherein the simulation data is indicative of a first set of the plurality of aerial vehicles for providing one or more simulated flight itineraries at a respective time step of the operational time period, and
wherein the request is indicative of a second set of the plurality of aerial vehicles for providing one or more simulated flight itineraries at the respective time step of the operational time period, wherein the second set is different from the first set.

8. The computer-implemented method of claim 7, wherein the second set of the plurality of aerial vehicles is greater than the first set of the plurality of aerial vehicles.

9. The computer-implemented method of claim 8, wherein each of the one or more servicing options are indicative of one or more additional aerial vehicles, a component state of one or more components of each of the one or more additional aerial vehicles, and contextual data indicative of one or more mitigating performance factors associated with the plurality of aerial vehicles.

10. The computer-implemented method of claim 7, wherein the second set of the plurality of aerial vehicles is less than the first set of the plurality of aerial vehicles.

11. The computer-implemented method of claim 10, wherein each of the one or more servicing options are indicative of one or more aerial vehicles of the first set of the plurality of aerial vehicles, a component state of one or more components of each of the one or more aerial vehicles, and contextual data indicative of one or more positive performance factors associated with the one or more aerial vehicles.

12. One or more tangible, non-transitory computer-readable media storing computer-readable instructions that when executed by one or more processors cause the one or more processors to perform operations, the operations comprising:
obtaining vehicle data associated with a plurality of aerial vehicles, wherein the vehicle data is indicative of a component state of one or more components for each of the plurality of aerial vehicles;
obtaining simulation data indicative of a plurality of simulated flight itineraries at one or more time steps throughout an operational time period, the plurality of simulated flight itineraries associated with at least one leg of a multi-modal transportation itinerary;
generating a servicing schedule for one or more anticipated servicing events during the operational time period based, at least in part, on the vehicle data and the simulation data; and
outputting the servicing schedule.

13. The one or more tangible, non-transitory computer-readable media of claim 12, wherein generating the servicing schedule for the one or more anticipated servicing events during the operational time period comprises:
determining an anticipated schedule for at least one aerial vehicle of the plurality of aerial vehicles based, at least in part, on the simulation data;
identifying an anticipated servicing event for the at least one aerial vehicle based, at least in part, on the anticipated schedule and vehicle data associated with the aerial vehicle; and
determining a servicing time period during the operational time period for the performance of the anticipated servicing event based, at least in part, on the anticipated servicing event, the vehicle data associated with the aerial vehicle, and the simulation data, wherein the servicing time period is determined to minimize the impact of the anticipated servicing event on the plurality of simulated flight itineraries.

14. The one or more tangible, non-transitory computer-readable media of claim 13, wherein an anticipated servicing event comprises one or more servicing attributes, the one or more servicing attributes comprising an aerial vehicle identifier identifying an aerial vehicle associated with the servicing event, a servicing type indicative of whether the anticipated servicing event is associated with refueling the aerial vehicle or repairing the aerial vehicle, and an estimated time or infrastructure for performing the anticipated servicing event.

15. The one or more tangible, non-transitory computer-readable media of claim 14, wherein generating the servicing schedule for the one or more anticipated servicing events comprises:
obtaining servicing data associated with one or more servicing locations and one or more servicing personnel, wherein the servicing data is indicative of an availability of the one or more servicing locations or the one or more servicing personnel; and
determining a servicing time period for the anticipated servicing event based, a least in part, on the servicing data, the one or more servicing attributes, and the simulation data.

16. The one or more tangible, non-transitory computer-readable media of claim 12, wherein outputting the servicing schedule comprises:
providing the servicing schedule as an input for updating the plurality simulated flight itineraries,
wherein the plurality of simulated flight itineraries are generated based, at least in part, on one or more operational constraints, wherein the one or more operational constraints comprise at least one of one or more demand constraints, multi-modal itinerary constraints, vehicle constraints, or environmental constraints for one or more time steps throughout the operational time period, and
wherein the one or more vehicle constraints are indicative of an availability of one or more of the plurality of aerial vehicles, and wherein the one or more vehicle constraints are updated based, at least in part, on the servicing schedule.

17. The one or more tangible, non-transitory computer-readable media of claim 16, wherein the one or more operational constraints are updated at each time step throughout the operational time period based, at least in part, on real time data indicative of the performance of at least one of the one or more anticipated servicing events.

18. The one or more tangible, non-transitory computer-readable media of claim 12, wherein each of the plurality of aerial vehicles comprise a fuel component, and wherein the vehicle data is indicative of a power level of the fuel component for each of the plurality of aerial vehicles.

19. The one or more tangible, non-transitory computer-readable media of claim 12, wherein the vehicle data is indicative of one or more operational capabilities for each of the plurality of aerial vehicles, one or more hardware components for each of the plurality of aerial vehicles, and a health of each of the one or more hardware components.

20. A computing system, comprising:
one or more processors; and
one or more tangible, non-transitory, computer readable media that collectively store instructions that when executed by the one or more processors cause the computing system to perform operations, the operations comprising:
obtaining vehicle data indicative of a plurality of vehicle attributes for a plurality of aerial vehicles;
obtaining simulation data indicative of a plurality of simulated flight itineraries at one or more time steps throughout an operational time period;
identifying one or more anticipated servicing events based on the simulation data and vehicle data;
generating a servicing schedule for the one or more anticipated servicing events; and
outputting the servicing schedule.
